(19) United States
(12) Patent Application Publication
(10) Pub. No.: US 2008/0055288 A1
(43) Pub. Date: Mar. 6, 2008

(54) Flat Display Apparatus and Driving Method for the Same

(75) Inventors: Toyoshi Kawada, Miyazaki (JP); Katsuhiro Ishida, Miyazaki (JP); Yuji Sano, Miyazaki (JP); Yoshinori Okada, Miyazaki (JP)

Correspondence Address: STAAS & HALSEY LLP, SUITE 700, 1201 NEW YORK AVENUE, N.W., WASHINGTON, DC, 20005, US

(73) Assignee: FUJITSU HITACHI PLASMA DISPLAY LIMITED, HIGASHIMOROKATA (JP)

(21) Appl. No.: 11/628,060

(22) PCT Filed: Apr. 11, 2005
(86) PCT No.: PCT/JP05/07044

§ 371 Date: Nov. 30, 2006

(30) Foreign Application Priority Data
Aug. 5, 2004 (JP) 2004-229474

(51) Int. Cl. G09G 5/00; G09G 3/28

(52) U.S. Cl. 345/204; 345/60

(57) ABSTRACT

A flat display apparatus comprises a flat display panel in which at least some of display electrodes are formed from a scan electrode and an address electrode arranged so as to intersect each other, and has a characteristic such that as the amount of driving load of the flat display panel increases, the activation energy of discharge gas increases and the panel driving voltage decreases. In a driving method for the flat display apparatus, when the amount of driving load of the flat display panel increases (S1 to S4), the driving voltage of the scanning electrode or the driving voltage (Vd) of the address electrode is reduced.

### TECHNICAL FIELD

The present invention relates to a flat display apparatus and a driving method for the same, and more particularly to a flat display apparatus, such as a plasma display panel (PDP), that is self-emissive, can achieve a large-screen display, and consumes relatively large power, and a driving method for the same.

### BACKGROUND ART

In recent years, flat panel displays have been supplanting traditional CRT-based displays and finding wide practical application as displays ranging from small-area to large-area displays. Liquid crystal displays (LCDs) and organic electroluminescent (EL) displays, as small-area displays, and plasma displays, as large-area displays, have been commercially implemented by exploiting their respective features. To promote further prevalence of flat panel displays in future, it is desired to further reduce the costs of the displays and improve their display characteristics while, at the same time, achieving significant improvements in functions and performance. Furthermore, today there is an increasing need to reduce environmental loads, and it is strongly demanded to reduce the power consumption of such displays in order to promote widespread use in ordinary homes.

As is known in the art, a surface-discharge type plasma display apparatus, for example, has been commercially implemented as a flat-panel image display apparatus; in this type of display apparatus, all pixels on the screen are driven simultaneously to emit light in accordance with the display image data. The surface-discharge type plasma display apparatus has a structure such that a pair of electrodes are formed on the inside surface of a front glass substrate and a rare gas is filled therein. When a voltage is applied between the electrodes, a surface discharge occurs at the surface of a protective layer and dielectric layer formed on the electrode surface, resulting in the emission of ultraviolet light. The inside surface of a rear glass substrate is coated with phosphors of three primary colors, red (R), green (G), and blue (B), which when excited by the ultraviolet light, produce visible light to achieve a color display.

FIG. 1 is a block diagram showing a three-electrode surface-discharge AC-driven type plasma display apparatus as one example of the prior art flat display apparatus.

As shown in FIG. 1, the plasma display apparatus 100 comprises a PDP (plasma display panel) 1, an address driver 3 for driving the display cells of the PDP 1, a scan driver 4, an X-common driver 5, a Y-common driver 6, and a control circuit 2 for controlling the respective drivers 3 to 6.

The control circuit 2 comprises a display data control section 21 for controlling the address driver 3 and a panel driving control section for controlling the scan driver 4, the X-common driver 5, and the Y-common driver 6; the control circuit 2 receives various synchronization signals (dot clock CLK, horizontal synchronization signal Hsync, and vertical synchronization signal Vsync) as well as display image data DATA representing the luminance levels of three primary colors, R, G, and B, from an external apparatus such as a TV tuner or a computer, and supplies suitable control signals to the address driver 3, the scan driver 4, the X-common driver 5, and the Y-common driver 6 in order to produce a desired image display. Here, the display data control section 21 includes a frame memory 21 for temporarily storing the input display image data, while the panel driving control section 22 includes a scan driver controller 221 for controlling the scan driver 4 and a common driver controller 222 for controlling the X-common driver 5 and the Y common driver.

The address driver 3 is constructed as an address driver IC for generating an address pulse (address discharge voltage) corresponding to the display image data DATA for individual address electrodes A1 to Am(16); the X-common driver 5 is constructed as an X-common driver circuit for generating a sustain pulse (sustain discharge voltage) for X electrodes X1 to Xn(12); the Y-common driver 6 is constructed as a Y-common driver circuit for generating a sustain pulse for Y electrodes Y1 to Yn(13) via the scan driver 4; and the scan driver 4 is constructed as a scan driver IC for driving the Y electrodes Y1 to Yn independently of each other for scanning.

Work has been proceeding in recent years to develop a scan driver IC that incorporates a sustain pulse generating function, thereby eliminating the need for the Y-common driver 6 as the sustain pulse generating circuit and achieving a reduction in size. Driving waveforms generated by the address driver 3, the scan driver 4, the X-common driver 5, and the Y-common driver 6, and having prescribed voltage levels to be applied to the respective electrodes, will be described later with reference to FIG. 5.

FIG. 2 is a plan view showing one example of the panel (PDP: three-electrode surface-discharge AC-driven type plasma display panel) in the plasma display apparatus shown in FIG. 1, and FIG. 3 is a cross-sectional view (transverse section) showing one example of the panel in the plasma display apparatus shown in FIG. 1.

In FIGS. 2 and 3, reference numeral 1 indicates the PDP, 11 the front glass substrate, 12 the X electrodes (X1 to Xn), 13 the Y electrodes (Y1 to Yn), 14 and 17 dielectric layers, 15 the rear glass substrate, 16 the address electrodes (A1 to Am), 18 the phosphors, and 19 barrier ribs. In practice, the structure of the PDP 1 is such that the X electrodes 12 and 13, for example, are formed as transparent electrodes and bus electrodes, respectively, and a protective layer is formed on the outside of each of the dielectric layers 14 and 17.

Further, the gap between the front glass substrate 11, on which the X electrode 12 and Y electrode 13 are formed, and the rear glass substrate 16, on which the address electrodes 16 are formed so as to intersect at right angles with the X electrode 12 and Y electrode 13, is filled with a discharge gas such as a neon/xenon mixture gas, and a discharge space at each intersection between the address electrodes and the X and Y electrodes forms one discharge cell.

In the address electrode structure of the PDP 1, a relatively small capacitor (parasitic capacitor) Cg is formed between opposing electrodes (between address electrode 16 and X electrode 12 or between address electrode 16 and Y electrode 13) because of the interposition of the glow discharge gas space, while on the other hand, a relatively large capacitor (parasitic capacitor) Ca is formed between adjacent electrodes (for example, between adjacent address electrodes) because of the presence of an insulating layer between them. The power consumption of the plasma display apparatus increases with increasing frequencies of operation that causes the capacitor Ca between the adjacent electrodes to charge and discharge for each switching of scanning operation, and the power consumption becomes the largest when such charge and discharge occurs in every scanning operation.

A specific example of a display pattern for which the power consumption becomes the largest is a display pattern that causes the ON and OFF states to be reversed between adjacent address electrodes for each scanning operation; in the case of progressive scanning operation, a staggered dot pattern is a typical example. The power consumption when displaying such a pattern is about two to three times as large as that when displaying a standard average pattern.

FIG. 4 is a diagram showing one example of a grayscale sequence in the plasma display apparatus shown in FIG. 1.

As shown in FIG. 4, in the grayscale driving sequence of the plasma display apparatus, one frame (field) is divided into a plurality of subframes (subfields) SF1 to SFn, each having a prescribed luminance weight, and a desired grayscale is achieved by combining these subframes. More specifically, the plurality of subframes consist of eight subframes SF1 to SF8 each assigned a luminance weight expressed, for example, as a power of 2 (the ratio of the number of sustain discharges among the subframes is set as 1:2:4:8:16:32:64:128), and a display with 256 grayscale levels is achieved by combining them. In the grayscale driving sequence of the actual plasma display apparatus, however, rather than setting each luminance weight as a power of 2, various modifications are made, for example, by setting the luminance weight of each of the subframes SF1 to SF8 as appropriate, or by providing a plurality of subframes having the same luminance weight.

FIG. 5 is a diagram showing an example of a driving waveform for the plasma display apparatus shown in FIG. 1; here, the basic driving waveforms to be applied to the respective electrodes for displaying an image are shown in simplified form.

As shown in FIG. 5 and in FIG. 4, the driving waveform for one subframe (SF) in the prior art plasma display apparatus comprises a reset period TR, an address period TA, and a sustain period TS; first, in the reset period TR, each display pixel is initialized, next in the address period TA each pixel to be displayed is selected, and finally in the sustain period, each selected pixel is caused to emit light, thus producing a display with desired brightness.

In the address period, a scan pulse of −Vy level is applied to the scan electrodes, i.e., the Y electrodes (Y1 to Yn: 13), in sequence by switching from one electrode to the next and, in synchronism with the application of the scan pulse to each Y electrode, an address pulse of Va level is applied to each address electrode (A1 to Am: 13), thereby selecting pixels on the Y electrode.

In the sustain period TS, sustain pulses of common levels Vsy and Vsx (sustain discharge voltage) are applied to all the scan electrodes (Y1 to Yn: 13) and common X electrodes (X1 to Xn: 12) in alternating fashion, thus causing the selected pixels to emit light, and a display with desired brightness is produced by continuous application of such pulses. A desired grayscale image is displayed by controlling the number of emissions by appropriately combining the basic operations of these series of driving waveforms.

As earlier described, the power consumption of the address electrode driver in the plasma display apparatus increases with increasing frequencies of operation that causes the capacitor Ca between the adjacent electrodes to charge and discharge for each switching of scanning operation; in the prior art, to reduce the power consumption of the address driver, there is proposed a plasma display apparatus in which a prescribed time lag is provided between the rising of the address pulse signal for a first address electrode and the falling of the address pulse signal for a second address electrode adjacent to the first address electrode (for example, refer to patent document 1).

Further, in a prior art driving method for a plasma display panel (PDP) of the type in which electrons are always stored on the scan electrode side, there is proposed a plasma display apparatus wherein provisions are made to increase bias voltage in order to compensate for the display characteristics of the PDP by preventing the electrons stored on the scan electrode side from tending to be emitted as the temperature of the PDP rises (for example, refer to patent document 2).

In the prior art, there is also proposed a PDP display apparatus comprising a PDP driving circuit for supplying driving power to the PDP and a controller for controlling the driving power wherein the PDP driving circuit outputs the driving power based on a power correction value generated by a voltage adjusting circuit included in the controller (for example, refer to patent document 3). The prior art further proposes a plasma display apparatus wherein when the panel temperature rises or when the panel is driven for an extended period of time, the voltage to be applied to the scan electrodes during the write period except the period of scan pulse application is increased, thereby preventing the generation of unwanted discharge that can significantly degrade the display ON state (for example, refer to patent document 4).

Patent document 1: Japanese Unexamined Patent Publication (Kokai) No. 10-123998

Patent document 2: Japanese Unexamined Patent Publication (Kokai) No. 09-006283

Patent document 3: Japanese Unexamined Patent Publication (Kokai) No. 2003-015593

Patent document 4: Japanese Unexamined Patent Publication (Kokai) No. 2003-122296

### DISCLOSURE OF THE INVENTION

### Problem to be Solved by the Invention

The plasma display apparatus, which is a self-emissive display apparatus as earlier described, has a characteristic such that as the ratio (display ratio) of the ON display cells to the total number of cells of the panel increases, the power consumption increases because of the increase of the gas discharge current; in view of this, the increase of the power consumption is suppressed by employing a strategy such as reducing the frequency of the sustain voltage waveform as the display ratio increases.

This strategy, however, has a limitation from the standpoint of ensuring display quality, because reducing the frequency of the sustain voltage waveform leads to reducing the brightness of the display. That is, the frequency of the sustain voltage waveform cannot be reduced below a certain frequency, and as a result, a design that allows for a given consumption power value becomes necessary.

The driving circuits (drivers) where such power consumption occurs are the scan driver IC block (scan driver 4) on the scan electrode side and the individual driving circuit component block (X-common driver 5 and Y-common driver 6) on the common electrode side; accordingly, thermal design that provides these drivers with heat dissipation performance that allows for a certain amount of power consumption becomes necessary.

To compare the thermal design for the scan driver IC block with that for the driving circuit component block, the driving circuit component block comprises, for example, individual devices such as FETs and, since the device structure is simple, and the number of connecting terminals is small, a good thermal design can be achieved at low cost and in a relatively simple manner, while on the other hand, the scan driver IC block comprises, for example, a plurality of ICs having many terminals and mounted on a flexible substrate, and as a result, providing each IC with a uniform heat sinking structure relatively free from variation is costly as it requires a complex structure design. Therefore, it is desired to simplify the heat sinking structure as much as possible for the scan driver IC block. Needless to say, for the ICs used as the X-common driver 5, the Y-common driver 6, and the address driver 3 also, if a simple heat sinking design can suffice for the purpose, it would be the best.

Further, in the prior art, if the power for address driving can be reduced by controlling the address pulse application timing, the characteristic that peak power occurs, for example, when displaying a staggered dot pattern remains unaddressed. There is also employed a strategy that monitors the driving current or device temperature on the address electrode side and, when they increase, reduces the number of subframes, thereby equivalently reducing the address frequency to reduce the peak power, but this strategy is not so preferable from the standpoint of ensuring display quality because the grayscale rendition degrades when the number of subframes is reduced.

FIG. 6 is a diagram showing the relationships between the panel temperature, the display ratio, and the driving voltage in the prior art plasma display apparatus.

First, as shown in FIG. 6, the voltage (driving voltage) of the drive pulses (such as the address pulse, scan pulse, common electrode sustain pulse, and reset pulse) is defined by a maximum driving voltage (Vdmax) and a minimum driving voltage (Vdmin), and the drive pulse to be applied to each electrode must be set to a voltage level between the maximum and minimum driving voltages.

The present inventors have discovered that there is a certain law between the panel temperature, the display ratio, and the driving voltage (maximum and minimum driving voltages) in the prior art plasma display apparatus such as shown in FIGS. 1 to 5. More specifically, it has been confirmed that, in the prior art plasma display apparatus such as shown in FIGS. 1 to 5, when the panel temperature rises, the driving voltage can be made lower than when the panel temperature is low and, when the display ratio increases, the driving voltage can be made lower than when the display ratio is low.

That is, among the state S1 in which the panel temperature is low and the display ratio is also low, the state S2 in which the panel temperature is high but the display ratio is low, the state S3 in which the panel temperature is low but the display ratio is high, and the state S4 in which the panel temperature is high and the display ratio is also high, it has been confirmed that when the panel temperature rises, the panel can be driven (the discharge can be produced) by a lower driving voltage and, when the display ratio increases, the panel can be driven (the discharge can be produced) by a lower driving voltage, as shown in FIG. 6. The reason for this is believed to be that as the panel temperature rises, the space charge occurring within each cell of the panel due to the discharge increases and, as a result, the discharge can be produced by a drive pulse of lower voltage, and that as the display ratio increases, the proportion of the cells simultaneously discharged in the panel increases, increasing the space charge supplied to the entire cells, as a result of which the discharge can be produced by a drive pulse of lower voltage.

In FIG. 6, it will be appreciated that the states S2 and S3 may be reversed depending on the actual panel temperature (differences in “LOW” and “HIGH” panel temperatures) and display ratio (differences in “LOW” and “HIGH” display ratios). Here, the panel temperature shown in FIG. 6 can be measured, for example, by attaching a temperature sensor to the rear metal plate of the panel, as will be described later in the description of the flat display apparatus according to the present invention, and the display ratio can be obtained directly from the display image data (DATA) or from values measured by the current sensor, temperature sensor, etc. provided for each driver.

As shown in FIG. 6, in the prior art plasma display apparatus (flat display apparatus), the driving voltage of the drive pulses (such as the address pulse, scan pulse, common electrode sustain pulse, and reset pulse) has been set as a fixed voltage within the voltage margin that satisfies all the above states S1 to S4. That is, in the prior art plasma display apparatus, the drive pulses are set at a constant voltage, regardless of the panel temperature or the display ratio, and it cannot be said that the prior art provides means that simplifies the thermal measures by sufficiently reducing the power consumption of the driver ICs.

In view of the problem associated with the prior art flat display panel described above, it is an object of the present invention to provide a flat display apparatus that can reduce the power consumption required for driving, while also achieving reductions in the size and cost of its associated circuit components, and a driving method for the same.

### Means for Solving the Problem

According to a first aspect of the present invention, there is provided a flat display apparatus having a flat display panel in which at least some of display electrodes are formed from a scan electrode and an address electrode arranged so as to intersect each other; a scan driver which is connected to the scan electrode and supplies a driving voltage waveform to the scan electrode; an address driver which is connected to the address electrode and supplies a driving voltage waveform to the address electrode; and a control circuit which controls operation of driving circuits in the flat display panel, the driving circuits including the scan driver and the address driver, wherein the flat display apparatus comprises a driving load detecting unit detecting an amount of driving load for the scan driver or the address driver; and a driving voltage varying unit varying, based on the detected amount of driving load, a driving voltage for the scan electrode or a driving voltage for the address electrode.

According to a second aspect of the present invention, there is provided a flat display apparatus having a flat display panel in which at least some of display electrodes are formed from a scan electrode and an address electrode arranged so as to intersect each other; a scan driver which is connected to the scan electrode and supplies a driving voltage waveform to the scan electrode; an address driver which is connected to the address electrode and supplies a driving voltage waveform to the address electrode; and a control circuit which controls operation of driving circuits in the flat display panel, the driving circuits including the scan driver and the address driver, wherein the flat display apparatus comprises a panel temperature detecting unit detecting the temperature of the flat display panel; and a driving voltage varying unit varying, based on the detected temperature of the flat display panel, a driving voltage for the scan electrode or a driving voltage for the address electrode.

According to a third aspect of the present invention, there is provided a flat display apparatus having a flat display panel in which at least some of display electrodes are formed from a scan electrode and an address electrode arranged so as to intersect each other and a common electrode as a sustain electrode arranged in parallel to the scan electrode; a scan driver which is connected to the scan electrode and supplies a driving voltage waveform to the scan electrode; an address driver which is connected to the address electrode and supplies a driving voltage waveform to the address electrode; a common electrode driver which is connected to the common electrode and supplies a driving voltage waveform to the common electrode; and a control circuit which controls operation of driving circuits in the flat display panel, the driving circuits including the scan driver, the address driver, and the common electrode driver, wherein the flat display apparatus comprises a driving load detecting unit detecting an amount of driving load for the scan driver, the address driver, or the common electrode driver; and a driving voltage varying unit varying, based on the detected amount of driving load, a driving voltage for the scan electrode, a driving voltage for the address electrode, or a driving voltage for the common electrode driver.

According to a fourth aspect of the present invention, there is provided a flat display apparatus having a flat display panel in which at least some of display electrodes are formed from a scan electrode and an address electrode arranged so as to intersect each other and a common electrode as a sustain electrode arranged in parallel to the scan electrode; a scan driver which is connected to the scan electrode and supplies a driving voltage waveform to the scan electrode; an address driver which is connected to the address electrode and supplies a driving voltage waveform to the address electrode; a common electrode driver which is connected to the common electrode and supplies a driving voltage waveform to the common electrode; and a control circuit which controls operation of driving circuits in the flat display panel, the driving circuits including the scan driver, the address driver, and the common electrode driver, wherein the flat display apparatus comprises a panel temperature detecting unit detecting the temperature of the flat display panel; and a driving voltage varying unit varying, based on the detected temperature of the flat display panel, a driving voltage for the scan electrode, a driving voltage for the address electrode, or a driving voltage for the common electrode driver.

According to a fifth aspect of the present invention, there is provided a driving method for a flat display apparatus that comprises a flat display panel in which at least some of display electrodes are formed from a scan electrode and an address electrode arranged so as to intersect each other, the flat display apparatus having a characteristic such that as the amount of driving load of the flat display panel increases, activation energy of discharge gas increases and a driving voltage decreases, wherein the method is characterized in that when the amount of driving load of the flat display panel increases, the driving voltage of the scan electrode or the address electrode is reduced.

According to a sixth aspect of the present invention, there is provided a driving method for a flat display apparatus that comprises a flat display panel in which at least some of display electrodes are formed from a scan electrode and an address electrode arranged so as to intersect each other, the flat display apparatus having a characteristic such that as the temperature of the flat display panel rises, activation energy of discharge gas increases and a driving voltage decreases, wherein the method is characterized in that when the temperature of the flat display panel rises, the driving voltage of the scan electrode or the address electrode is reduced.

According to a seventh aspect of the present invention, there is provided a driving method for a flat display apparatus that comprises a flat display panel in which at least some of display electrodes are formed from a scan electrode and an address electrode arranged so as to intersect each other and a common electrode as a sustain electrode arranged in parallel to the scan electrode, the flat display apparatus having a characteristic such that as the amount of driving load of the flat display panel increases, activation energy of discharge gas increases and a driving voltage decreases, wherein the method is characterized in that when the amount of driving load of the flat display panel increases, the driving voltage of the scan electrode, the address electrode, or the common electrode is reduced.

According to an eighth aspect of the present invention, there is provided a driving method for a flat display apparatus that comprises a flat display panel in which at least some of display electrodes are formed from a scan electrode and an address electrode arranged so as to intersect each other and a common electrode as a sustain electrode arranged in parallel to the scan electrode, the flat display apparatus having a characteristic such that as the temperature of the flat display panel rises, activation energy of discharge gas increases and a driving voltage decreases, wherein the method is characterized in that when the temperature of the flat display panel rises, the driving voltage of the scan electrode, the address electrode, or the common electrode is reduced.

### EFFECT OF THE INVENTION

According to the present invention, it becomes possible to provide a flat display apparatus that can reduce the power consumption required for driving, while also achieving reductions in the size and cost of its associated circuit components by simplifying their heat sinking structures, and a driving method for such a flat display apparatus.

### BRIEF DESCRIPTION OF THE DRAWINGS

FIG. 1 is a block diagram showing a three-electrode surface-discharge AC-driven type plasma display apparatus as one example of a prior art flat display apparatus.

FIG. 2 is a plan view showing one example of a panel (PDP) in the plasma display apparatus shown in FIG. 1.

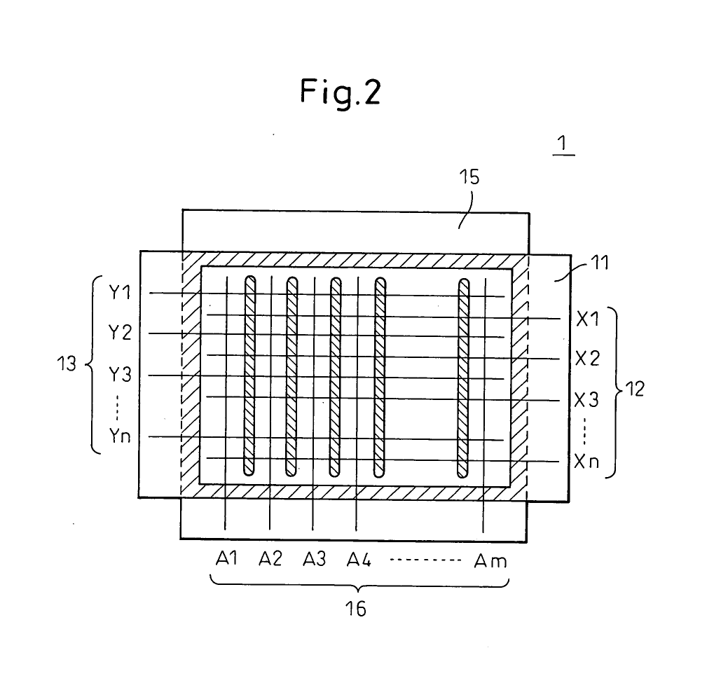

FIG. 3 is a cross-sectional view showing one example of the panel in the plasma display apparatus shown in FIG. 1.

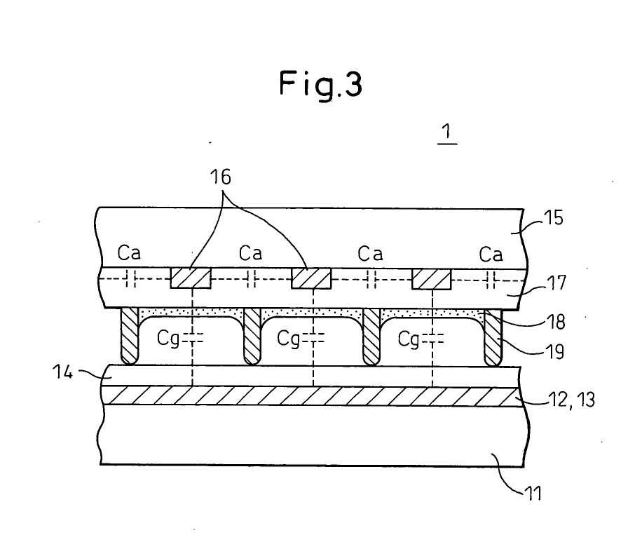

FIG. 4 is a diagram showing one example of a grayscale sequence in the plasma display apparatus shown in FIG. 1.

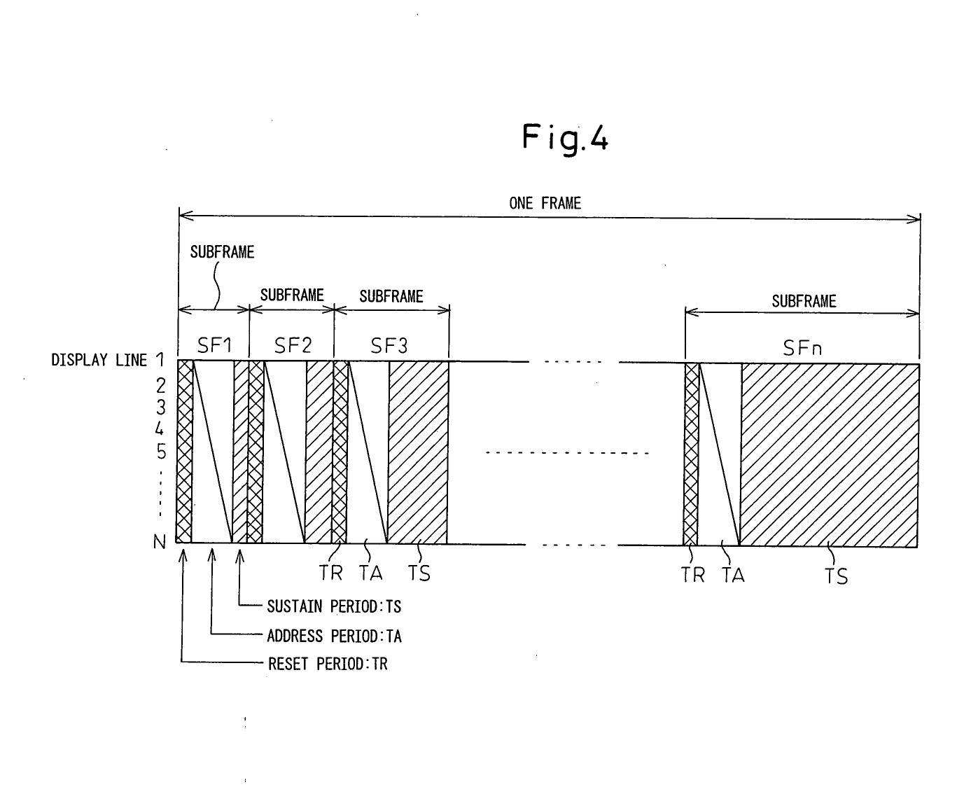

FIG. 5 is a diagram showing an example of a driving waveform for the plasma display apparatus shown in FIG. 1.

FIG. 6 is a diagram showing the relationships between panel temperature, display ratio, and driving voltage in the prior art plasma display apparatus.

FIG. 7 is a block diagram schematically showing a three-electrode surface-discharge AC-driven type plasma display apparatus as one example of a flat display apparatus according to the present invention.

FIG. 8 is a diagram showing the relationships between panel temperature, display ratio, and driving voltage in the plasma display apparatus as one example of the flat display apparatus according to the present invention.

FIG. 9 is a diagram for explaining a first embodiment of the flat display apparatus according to the present invention.

FIG. 10 is a diagram for explaining a second embodiment of the flat display apparatus according to the present invention.

FIG. 11 is a diagram for explaining a third embodiment of the flat display apparatus according to the present invention.

FIG. 12 is a diagram for explaining a fourth embodiment of the flat display apparatus according to the present invention.

FIG. 13 is a diagram for explaining a fifth embodiment of the flat display apparatus according to the present invention.

FIG. 14 is a diagram (part 1) for explaining a sixth embodiment of the flat display apparatus according to the present invention.

FIG. 15 is a diagram (part 2) for explaining the sixth embodiment of the flat display apparatus according to the present invention.

FIG. 16 is a diagram for explaining a seventh embodiment of the flat display apparatus according to the present invention.

FIG. 17 is a diagram showing the relationships between panel temperature, display ratio, driving voltage, and pulse width in the plasma display apparatus as one example of the flat display apparatus according to the present invention.

FIG. 18 is a diagram for explaining an eighth embodiment of the flat display apparatus according to the present invention.

FIG. 19 is a diagram for explaining a ninth embodiment of the flat display apparatus according to the present invention.

FIG. 20 is a diagram for explaining a 10th embodiment of the flat display apparatus according to the present invention.

FIG. 21 is a diagram for explaining an 11th embodiment of the flat display apparatus according to the present invention.

FIG. 22 is a diagram for explaining a 12th embodiment of the flat display apparatus according to the present invention.

FIG. 23 is a diagram for explaining a 13th embodiment of the flat display apparatus according to the present invention.

FIG. 24 is a diagram for explaining a 14th embodiment of the flat display apparatus according to the present invention.

FIG. 25 is a diagram (part 1) for explaining a 15th embodiment of the flat display apparatus according to the present invention.

FIG. 26 is a diagram (part 2) for explaining the 15th embodiment of the flat display apparatus according to the present invention.

FIG. 27 is a diagram (part 3) for explaining the 15th embodiment of the flat display apparatus according to the present invention.

### EXPLANATION OF REFERENCE NUMERALS

1 PDP (PLASMA DISPLAY PANEL)
2 CONTROL CIRCUIT
3 ADDRESS DRIVER
4 SCAN DRIVER
5 X-COMMON DRIVER
6 Y-COMMON DRIVER
11 FRONT GLASS SUBSTRATE
12, X1 TO Xn X ELECTRODE
13, Y1 TO Yn Y ELECTRODE
14, 17 DIELECTRIC LAYER
15 REAR GLASS SUBSTRATE
16, A1 TO Am ADDRESS ELECTRODE
18 PHOSPHOR
19 BARRIER RIB
21 DISPLAY DATA CONTROL SECTION
22 PANEL DRIVING CONTROL SECTION
100 PLASMA DISPLAY APPARATUS
101, 301, 401, 501 TEMPERATURE SENSOR
211 FRAME MEMORY
221 SCAN DRIVER CONTROLLER
222 COMMON DRIVER CONTROLLER
302, 502, 601 CURRENT SENSOR
CLK DOT CLOCK
DATA DISPLAY IMAGE DATA
Hsync HORIZONTAL SYNCHRONIZATION SIGNAL
Vsync VERTICAL SYNCHRONIZATION SIGNAL

### BEST MODE FOR CARRYING OUT THE INVENTION

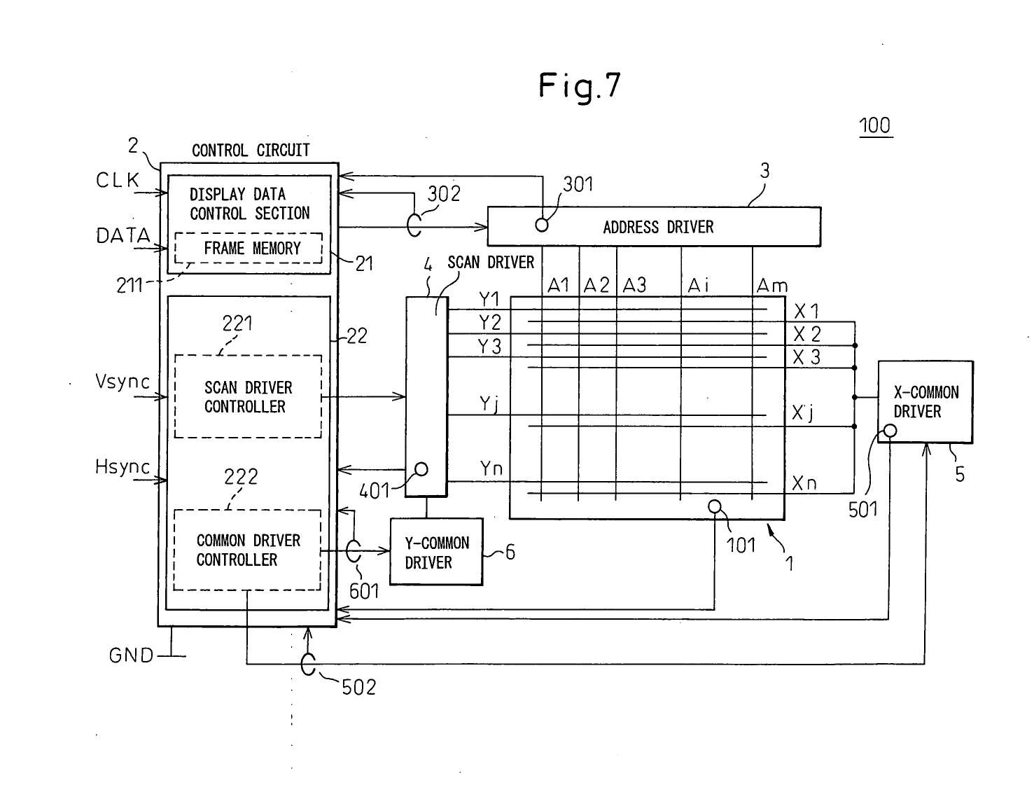

FIG. 7 is a block diagram schematically showing a three-electrode surface-discharge AC-driven type plasma display apparatus as one example of a flat display apparatus according to the present invention.

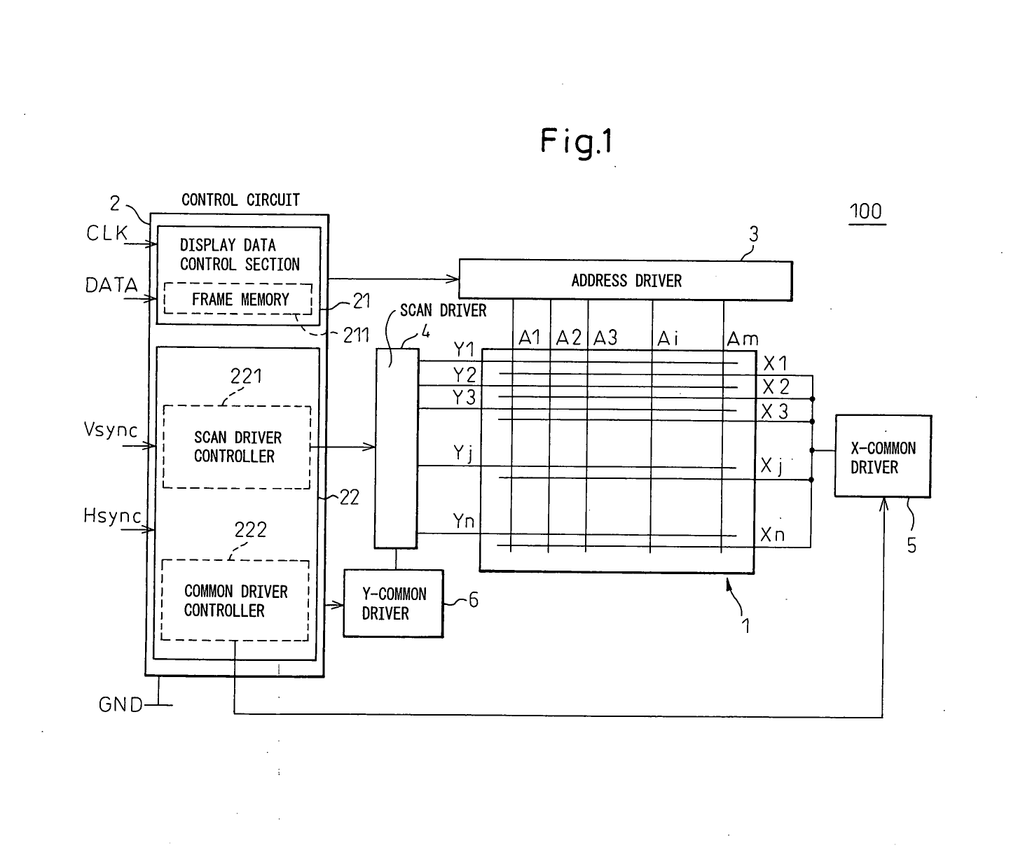

As is apparent from a comparison of FIG. 7 with the previously given FIG. 1, the three-electrode surface-discharge AC-driven type plasma display apparatus as one example of the flat display apparatus according to the present invention differs from the prior art plasma display apparatus shown in FIG. 1 by the inclusion of temperature sensors 101, 301, 401, and 501 and current sensors 302, 502, and 601, and is configured to perform the processing to be described in detail later. Otherwise, the configuration is the same as that of the plasma display apparatus described with reference to FIG. 1, and therefore, the description thereof will not be repeated here.

As shown in FIG. 7, the temperature sensor 101 is attached to the plasma display panel 1, and information on the measured panel temperature is sent to the control circuit 2. On the other hand, the address driver (address driver IC) 3 is provided with the temperature sensor 301 which measures the temperature of the address driver IC and sends the measured temperature information to the control circuit 2; the address driver 3 is also provided with the current sensor 302 which measures the current consumption of the address driver 3 and sends its information to the control circuit 2. The scan driver (scan driver IC) 4 is provided with the temperature sensor 401 which measures the temperature of the scan driver IC and sends the measured temperature information to the control circuit 2, while the Y-common driver 6 is provided with the current sensor 601 which measures the current consumption of the Y-common driver 6 and sends its information to the control circuit 2. The X-common driver (X-common driver circuit) 5 is provided with the temperature sensor 501 which measures the temperature of the X-common driver circuit and sends the measured temperature information to the control circuit 2; the X-common driver 5 is also provided with the current sensor 502 which measures the current consumption of the X-common driver 5 and sends its information to the control circuit 2.

The reason that the scan driver 4 provided with the temperature sensor is not provided with a current sensor is that the current is consumed primarily by the Y-common driver 6 that performs sustain discharge, while the temperature rise occurs primarily in the scan driver 4. Of course, each driver (driver IC) may be provided with both the temperature sensor and the current sensor, but various modifications can be made as required; for example, the current sensor may not be provided, but only the temperature sensor may be provided, or the temperature sensor may be provided only for a specific driver IC (for example, the address driver IC).

The data (temperature information and current information) measured by the temperature sensors and current sensors provided for the respective drivers are sent to the control circuit 2 which computes the amount of driving load of each driver from the measured data. Here, the amount of driving load can also be obtained directly from the actual display image data (DATA). The temperature of the plasma display panel 1 is measured by the temperature sensor 101 attached, for example, to the rear metal plate of the panel, and the panel temperature information is sent to the control circuit 2.

Then, as will be described below, control is performed to drive the panel (produce a discharge) by reducing the driving voltage as the panel temperature rises and to drive the panel (produce a discharge) by reducing the driving voltage as the display ratio increases.

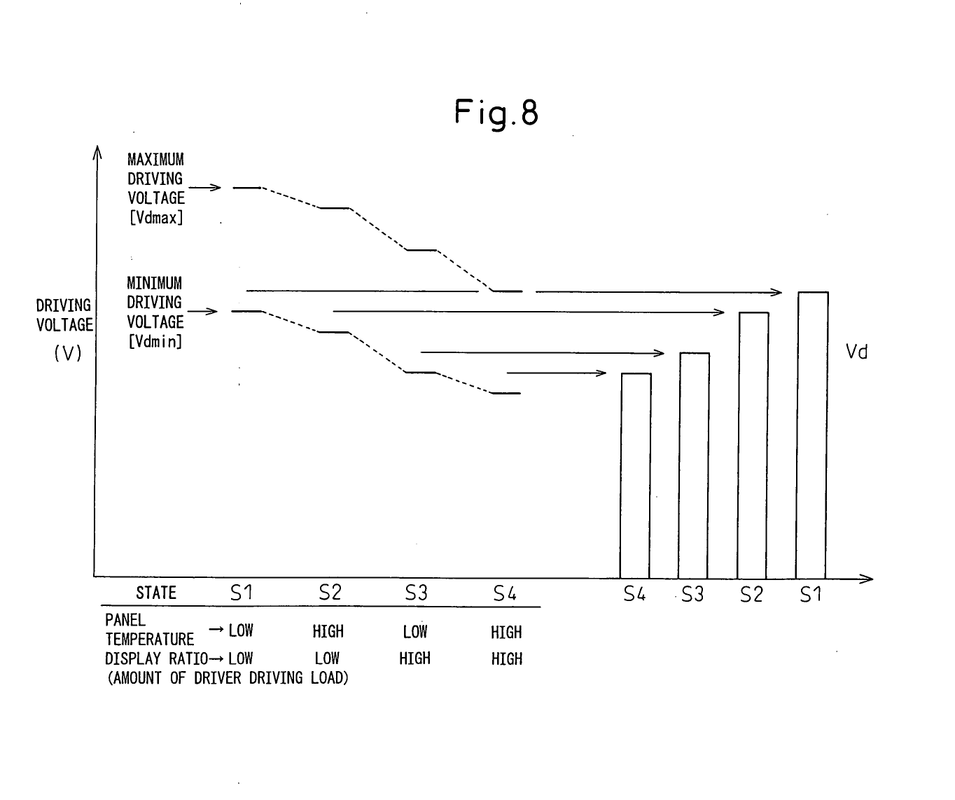

FIG. 8 is a diagram showing the relationships between the panel temperature, the display ratio, and the driving voltage in the plasma display apparatus as one example of the flat display apparatus according to the present invention.

As shown in FIG. 8, among the state S1 in which the panel temperature is low and the display ratio is also low, the state S2 in which the panel temperature is high but the display ratio is low, the state S3 in which the panel temperature is low but the display ratio is high, and the state S4 in which the panel temperature is high and the display ratio is also high, there exists a relationship such that when the panel temperature rises, the panel can be driven (the discharge can be produced) by a lower driving voltage and, when the display ratio increases, the panel can be driven (the discharge can be produced) by a lower driving voltage.

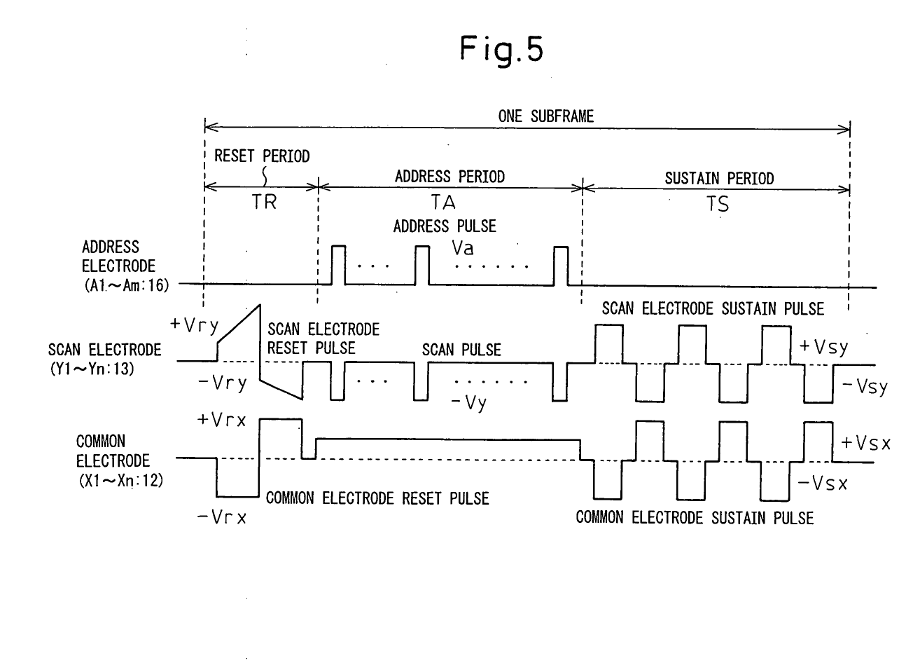

As previously described with reference to FIG. 5, for example, the plasma display panel is driven by high-voltage drive pulses whose polarity is periodically reversed, and produces a display by utilizing the glow discharge phenomenon of the rare gas filled into each display cell. Therefore, the optimum value of the driving voltage is influenced by the temperature of the panel itself. That is, as the panel temperature rises, the activation energy of the rare gas increases, making it easier to produce a discharge, and the required driving voltage thus tends to decrease; conversely, as the temperature decreases, the activation energy decreases, making it difficult to produce a discharge, and the required driving voltage thus tends to increase.

The optimum value of the driving voltage is also influenced by the number of cells that are turned on within the plasma display panel, i.e., the ratio (display ratio) of the number of cells caused to emit light by glow discharge to the total number of cells; that is, as the display ratio increases, the number of electrons or ions in the discharge gas space increases, making it easier to produce a discharge, and the required driving voltage thus tends to decrease and, conversely, as the display ratio decreases, the number of electrons or ions in the discharge gas space decreases, making it difficult to produce a discharge, and the required driving voltage thus tends to increase.

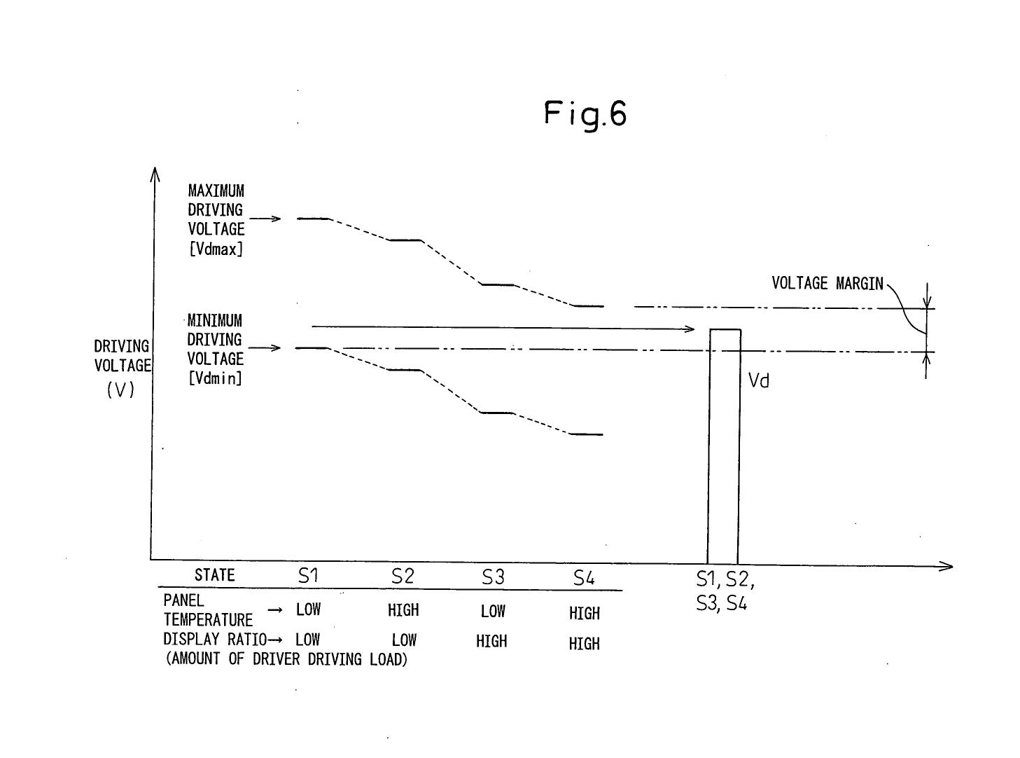

As is apparent from a comparison of FIG. 8 with the previously given FIG. 6, in the plasma display apparatus (flat display apparatus) according to the present invention, the driving voltage of the drive pulses (such as the address pulse, scan pulse, common electrode sustain pulse, and reset pulse) is not set as a fixed voltage for all the states S1 to S4, but control is performed to drive the panel by reducing the driving voltage as the panel temperature rises and to drive the panel by reducing the driving voltage as the display ratio increases.

More specifically, as shown in FIG. 8, the optimum driving voltage that can maintain a proper display state for all the cells of the panel is a voltage between the minimum driving voltage (Vdmin) and the maximum driving voltage (Vdmax) both of which are shown tending downward to the right to match the respective panel-temperature/display-ratio combination states S1 to S4.

In FIG. 8, the states S2 and S3 may be reversed depending on the actual panel temperature (differences in “LOW” and “HIGH” panel temperatures) and display ratio (differences in “LOW” and “HIGH” display ratios), as previously described.

As is apparent from a comparison of FIGS. 6 and 8, in the prior art flat display apparatus, the drive-pulse voltage (driving voltage) has been set as a fixed voltage that satisfies all the states S1 to S4, but in the flat display apparatus of the present invention, the driving voltage is set as an appropriate voltage within the range between the minimum driving voltage and the maximum driving voltage that vary depending on the respective states S1 to S4. More specifically, the driving voltage is set by detecting the panel-temperature/display-ratio combination state by the sensors, and by switching to the optimum drive pulse that matches the detected state. Further, by setting the driving voltage to a value close to the minimum driving voltage in each state, the overall driving power can be reduced. This means, for example, that the heat sink for the address driver IC can be reduced in size, compared with the prior art, or can even be eliminated.

Embodiments of the flat display apparatus according to the present invention and the driving method for the same will be described in detail below with reference to the accompanying drawings.

### EMBODIMENTS

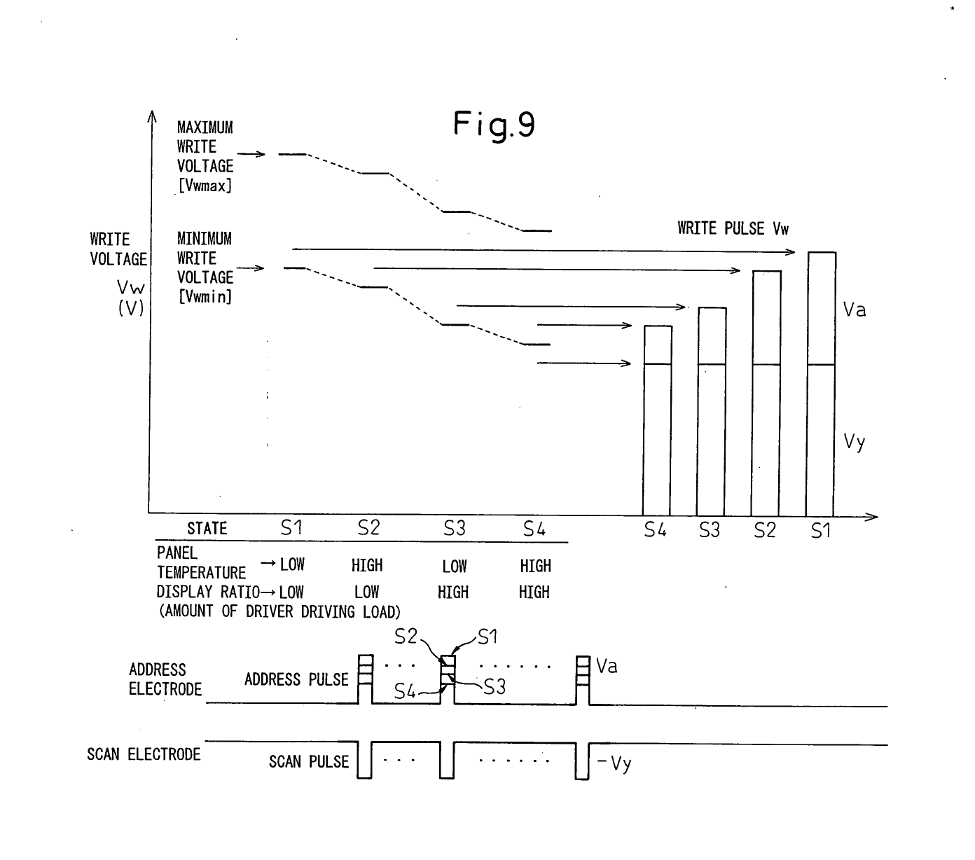

FIG. 9 is a diagram for explaining a first embodiment of the flat display apparatus according to the present invention. The first embodiment of the flat display apparatus is one in which the present invention is applied to the write pulse to be applied during the address period as a sum pulse representing the sum of the scan pulse to the scan electrode and the address pulse to the address electrode for writing to a selected cell.

As shown in FIG. 9, in the flat display apparatus (plasma display apparatus) according to the first embodiment, the scan-pulse voltage (driving voltage) Vy is set as high as possible within the minimum write voltage Vwmin for the state S4 (the lowest driving voltage state), and the overall write-pulse voltage Vw created by adding the address-pulse voltage Va to the scan-pulse voltage Vy is set as low as possible but higher than the minimum write voltage Vwmin for each of the states S1 to S4, the write-pulse voltage Vw thus being varied in accordance with the respective states S1 to S4.

For the states S1 to S4, the panel temperature can be detected directly by disposing a temperature detecting device such as a thermistor (for example, the temperature sensor 101 in FIG. 7) at a suitable position on the rear of the panel, or indirectly by disposing a plurality of temperature detecting devices at suitably distributed positions on a circuit board mounted in parallel to the rear of the panel. Here, the temperature sensors can be mounted upward of the rear metal plate of the panel, for example, by considering heat conduction, convection, etc.

On the other hand, the display ratio can be detected directly by counting the number of pieces of input display image data, or indirectly by detecting the sustain current value supplied from the sustain supply voltage (for example, by the current sensors 501 and 601 in FIG. 7) or detecting the current consumption of the address driver IC (address driver) (for example, by the current sensor 302 in FIG. 7) or by monitoring the temperatures of the driving devices such as the address driver IC, the scan driver IC, and the common sustain electrode driving circuit (X-common driver circuit) (for example, by the temperature sensors 301, 401, and 501 in FIG. 7) and detecting the amount of driving load from values indicating the temperature rises.

In accordance with the thus obtained panel temperature and display ratio, the applicable state during the panel driving is determined from among the states S1 to S4, and the address-pulse voltage Va is varied to match the determined state. Here, it will be appreciated that control may be performed by setting a larger number of states by combining the panel temperature and the display ratio. Alternatively, in order to simply the detection system or the control circuit, provisions may be made to determine the various states based only on the panel temperature or the display ratio; in that case also, the intended object can, of course, be accomplished.

In this way, according to the first embodiment of the flat display apparatus, the power requirements of the address driving power supply can be reduced, while also reducing the power consumption of the address driver IC itself; this serves to simplify the heat sink mounting structure for the address driver IC and to reduce the size and cost of its associated components.

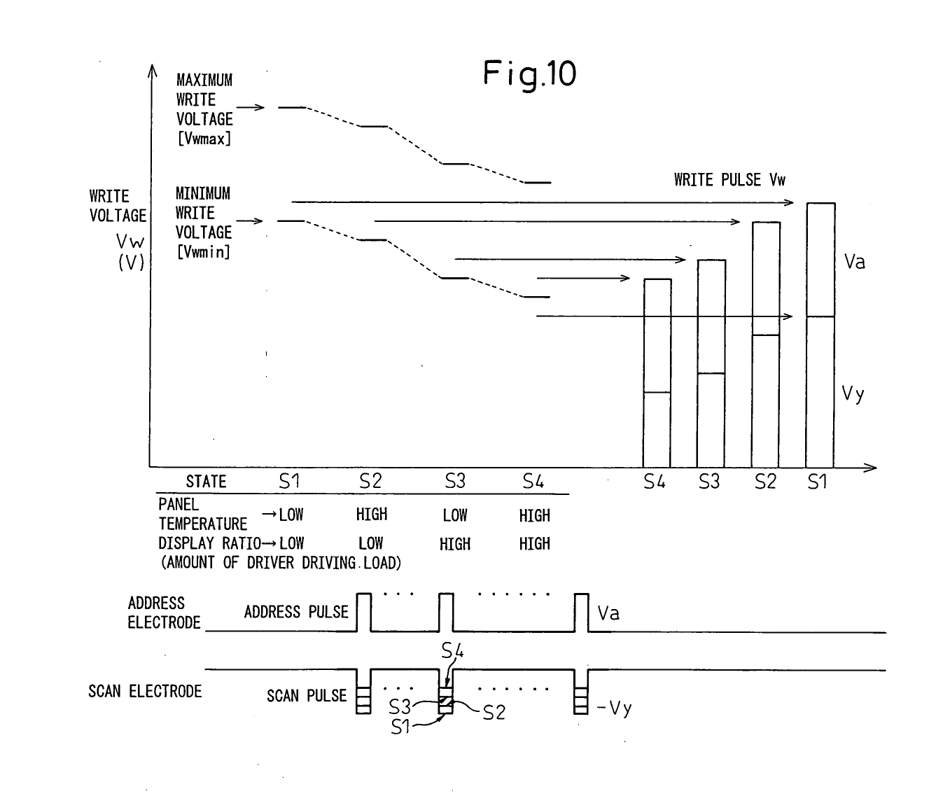

FIG. 10 is a diagram for explaining a second embodiment of the flat display apparatus according to the present invention.

As shown in FIG. 10, the second embodiment of the flat display apparatus is similar to the foregoing first embodiment in that the present invention is applied to the write pulse, but the difference is that, in the second embodiment, the scan-pulse voltage Vy is varied. The second embodiment is preferably applied to the case where the amount of driving load of the scan driver IC is larger when its monitored value is compared with that of the address driver IC. The embodiment is also preferably applied to the case where it is desired to simplify the heat sink mounting structure for the scan driver IC rather than that for the address driver IC.

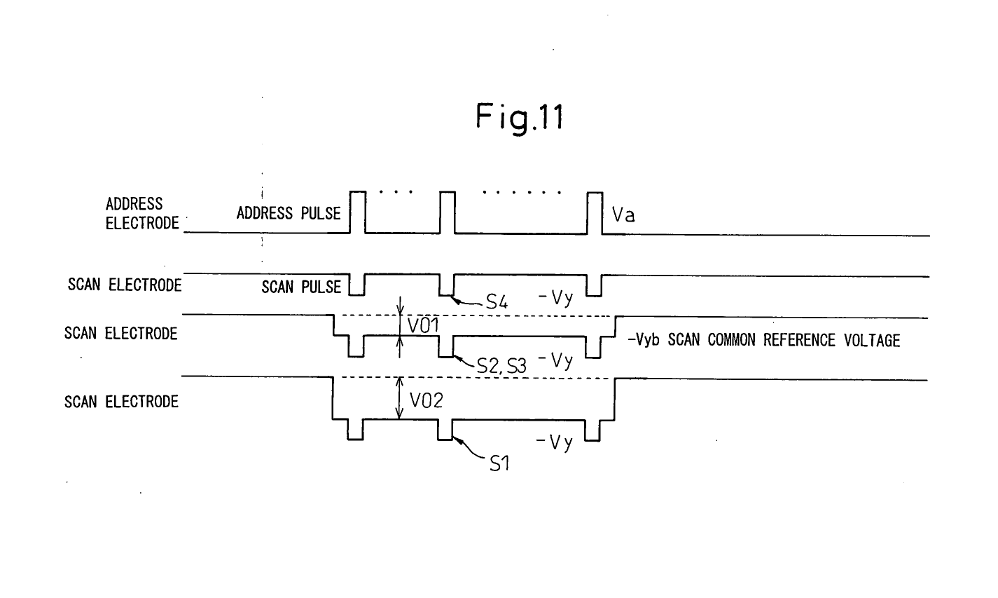

FIG. 11 is a diagram for explaining a third embodiment of the flat display apparatus according to the present invention. In FIG. 11, the states S2 and S3 are shown as the same state for convenience.

As shown in FIG. 11, the third embodiment of the flat display apparatus is substantially the same as the foregoing second embodiment, but differs in that the scan pulse output is not directly produced with respect to GND level (ground potential), but is produced by superimposing the scan pulse Vy on a common reference voltage −Vyb. That is, in the state S2 (S3), the potential difference of the common reference voltage −Vyb with respect to GND level is reduced (V01), but in the state S1, the potential difference of the common reference voltage −Vyb with respect to GND level is increased (V02), thus varying the scan-pulse voltage by varying the common reference voltage −Vyb.

In addition to offering the same effect as that achieved by the second embodiment, the third embodiment of the flat display apparatus is effective when there is a limit to the withstanding voltage of the scan driver IC or when a pulse greater than the withstanding voltage of the scan driver IC is output.

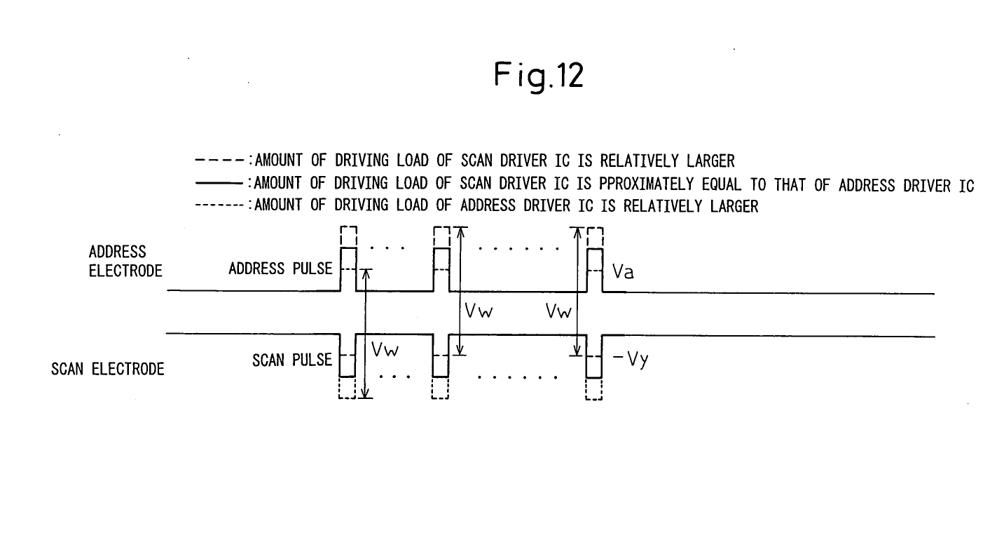

FIG. 12 is a diagram for explaining a fourth embodiment of the flat display apparatus according to the present invention.

As shown in FIG. 12, in the fourth embodiment of the flat display apparatus, the write-pulse voltage which is varied in accordance with the respective states S1 to S4 is set by comparing, for example, the amount of driving load of the address driver IC with that of the scan driver IC and by determining for which IC the amount of driving load is to be reduced preferentially.

The fourth embodiment of the flat display apparatus shows the case where the voltage is divided between the address driver side and the scan driver side while keeping the magnitude of the overall write-pulse voltage unchanged.

First, the state in which the amount of driving load of the address driver IC is approximately equal to that of the scan driver IC is chosen as the normal state and, in this normal state, the address voltage Va is generally set lower and the scan voltage Vy higher. The reason is that, in an ordinary display pattern, the driving on the scan electrode side is performed only once during the scanning of one screen, while on the other hand, the driving on the address side is performed a plurality of times corresponding to the scan driving of the plurality of scan electrodes, and as a result, the address driving frequency is higher and the power consumption on the address side tends to increase. Therefore, the address voltage Va is set lower and the scan voltage Vy higher because of the need to maintain a power consumption balance between the address driver side and the scan driver side. Here, FIG. 12 is only a schematic illustration and is drawn by ignoring the above voltage difference.

When the amount of driving load of the scan driver IC has relatively increased from the normal state, the scan voltage −Vy is reduced, and the address voltage Va is increased correspondingly.

Conversely, when the amount of driving load of the address driver IC has relatively increased from the normal state, the address voltage Va is reduced, and the scan voltage −Vy is increased correspondingly.

According to the flat panel display of the fourth embodiment, a well balanced heat sink design can be achieved for both the address driver IC and the scan driver IC.

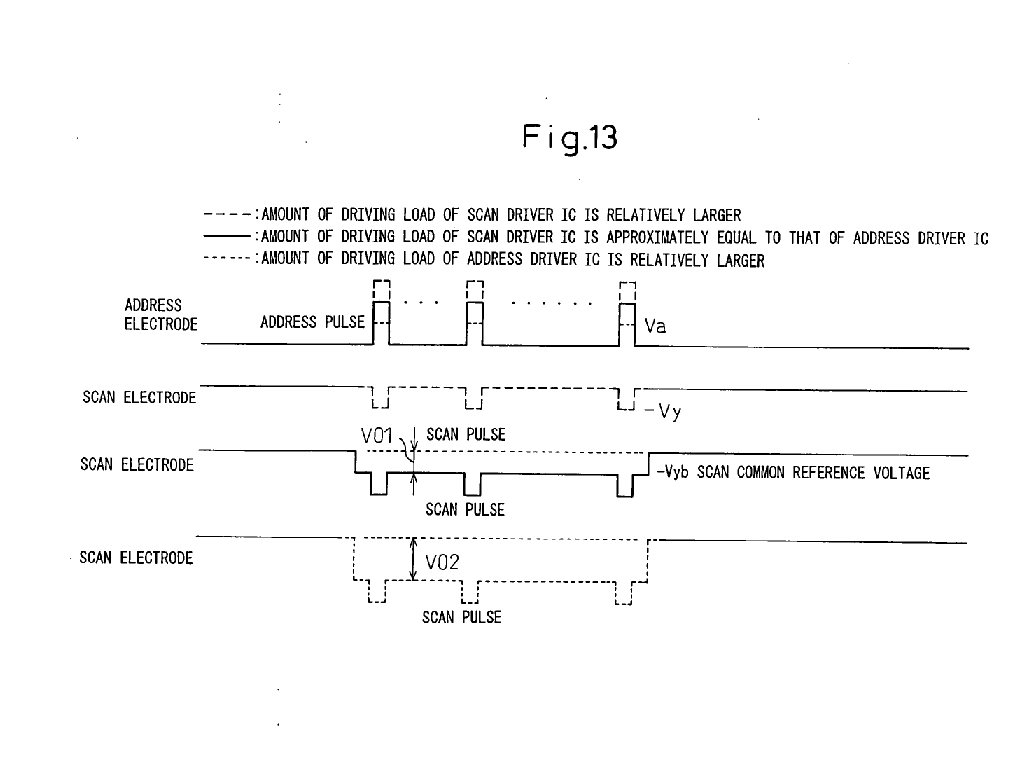

FIG. 13 is a diagram for explaining a fifth embodiment of the flat display apparatus according to the present invention.

As shown in FIG. 13, the fifth embodiment of the flat display apparatus is one in which the scan pulse superimposition method of the third embodiment explained with reference to FIG. 11 is applied to the above-described fourth embodiment, and the advantages of the respective embodiments can be accomplished simultaneously.

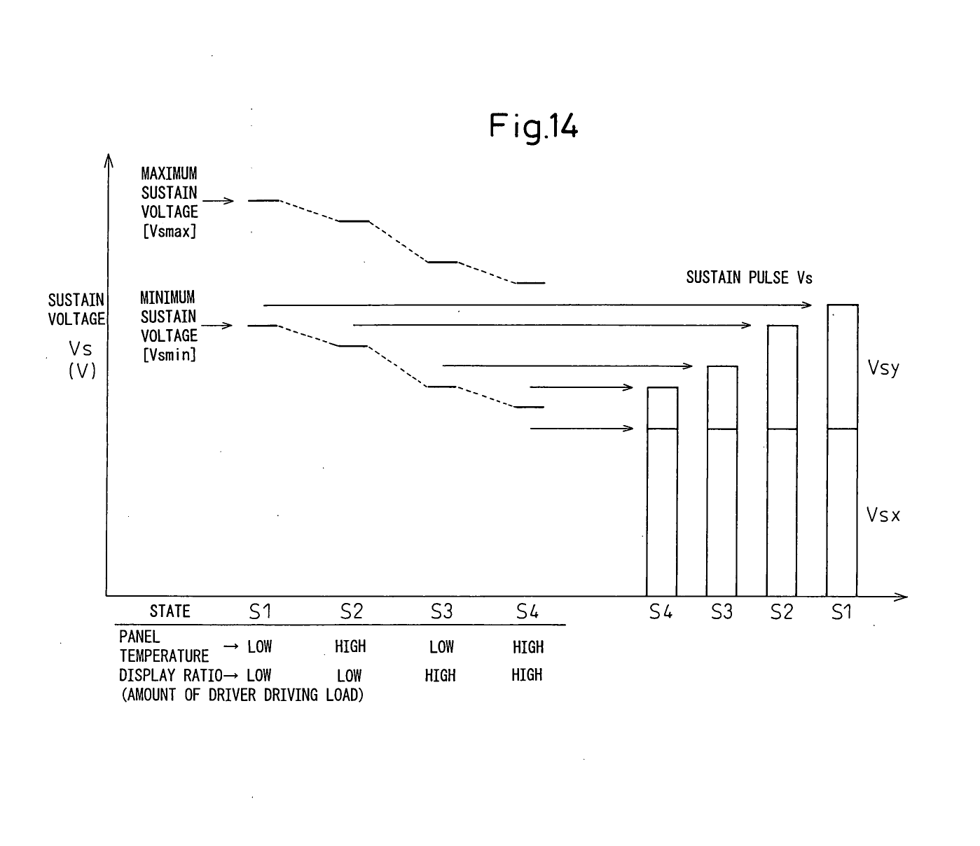

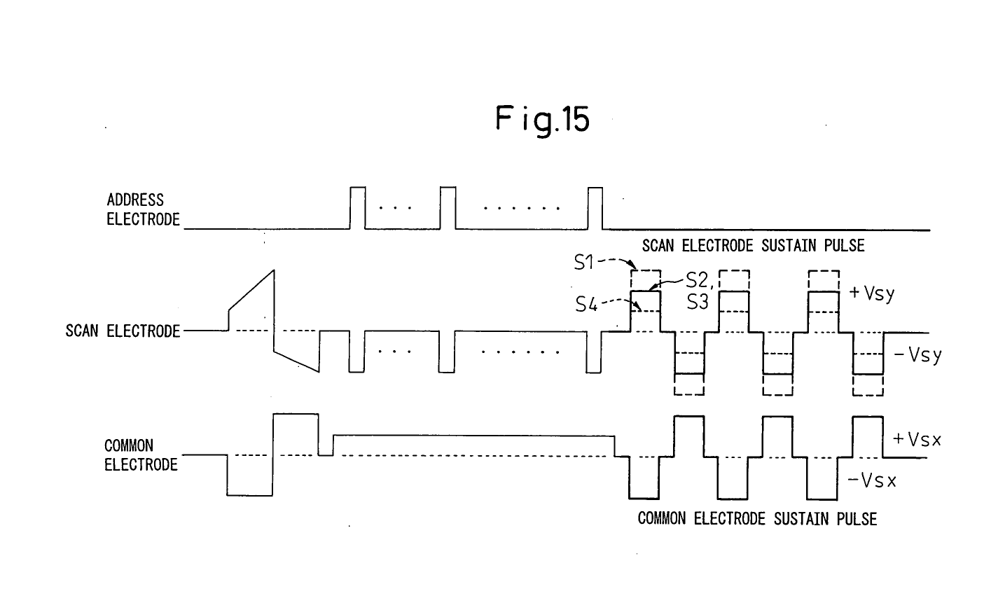

FIGS. 14 and 15 are diagrams for explaining a sixth embodiment of the flat display apparatus according to the present invention. In FIG. 15, the states S2 and S3 are shown as the same state for convenience.

As shown in FIGS. 14 and 15, the sixth embodiment of the flat display apparatus is one in which the present invention is applied to the sustain pulse. The respective states S1 to S4 are detected from the panel temperature and the display ratio, as earlier described, and the sustain-pulse voltage Vsy for the scanning electrodes are varied in accordance with the detected states S1 to S4.

According to the sixth embodiment of the flat display apparatus, the heat sink mounting structure for the scan driver IC can be simplified.

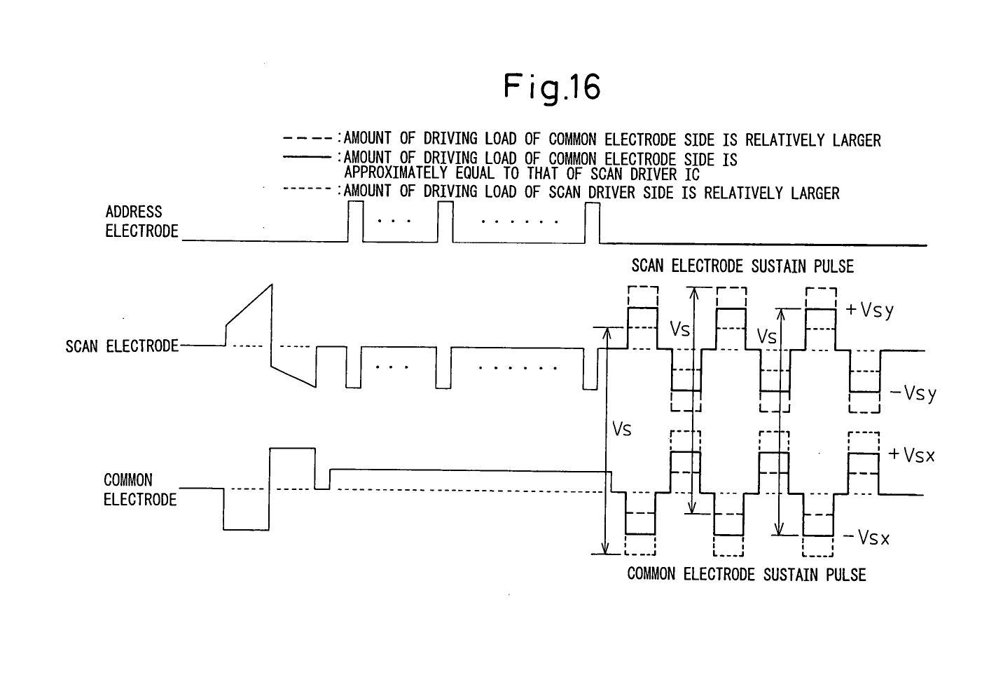

FIG. 16 is a diagram for explaining a seventh embodiment of the flat display apparatus according to the present invention.

As shown in FIG. 16, the seventh embodiment of the flat display apparatus is one in which the method of the fourth embodiment explained with reference to FIG. 12 is applied to the above-described sixth embodiment; that is, control is performed by comparing the amount of driving load of the scan driver IC with that of the common sustain electrode driving circuit (X-common driver circuit) and by determining for which driver the amount of driving load is to be reduced preferentially, and the magnitude of the sustain-pulse voltage itself is kept substantially unchanged.

According to the seventh embodiment of the flat display apparatus, an optimum total design can be accomplished that achieves a well balanced mounting structure for the common sustain electrode driving circuit (X-common driver circuit) as well as for the scan driver IC.

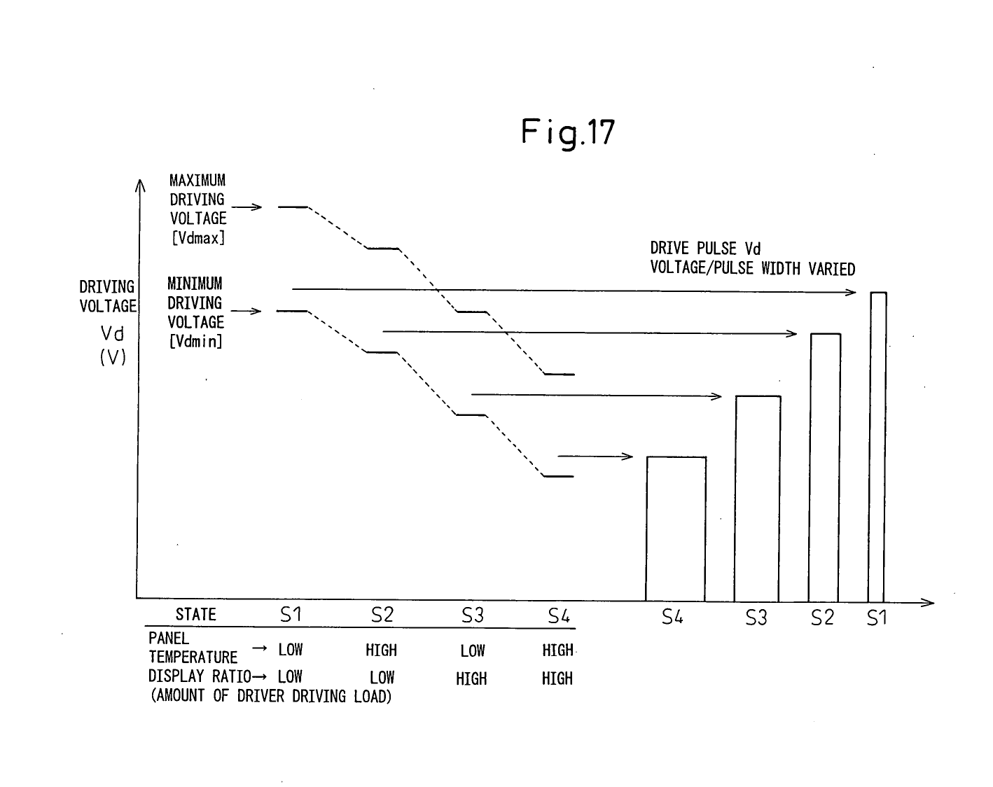

FIG. 17 is a diagram showing the relationships between the panel temperature, the display ratio, the driving voltage, and the pulse width in the plasma display apparatus as one example of the flat display apparatus according to the present invention.

In FIG. 17, the pulse width of the driving voltage (drive pulse) is also varied in the relationships between the panel temperature, the display ratio, and the driving voltage in the plasma display apparatus explained with reference to FIG. 8.

That is, by setting the pulse width of the drive pulse wider, the panel can be driven even if the discharge delay time of the gas discharge in the display pixel (cell) becomes longer; accordingly, by setting the pulse width wider while reducing the driving voltage as the state changes from S1 toward S4, the driving voltage can be further reduced compared with the case explained with reference to FIG. 8.

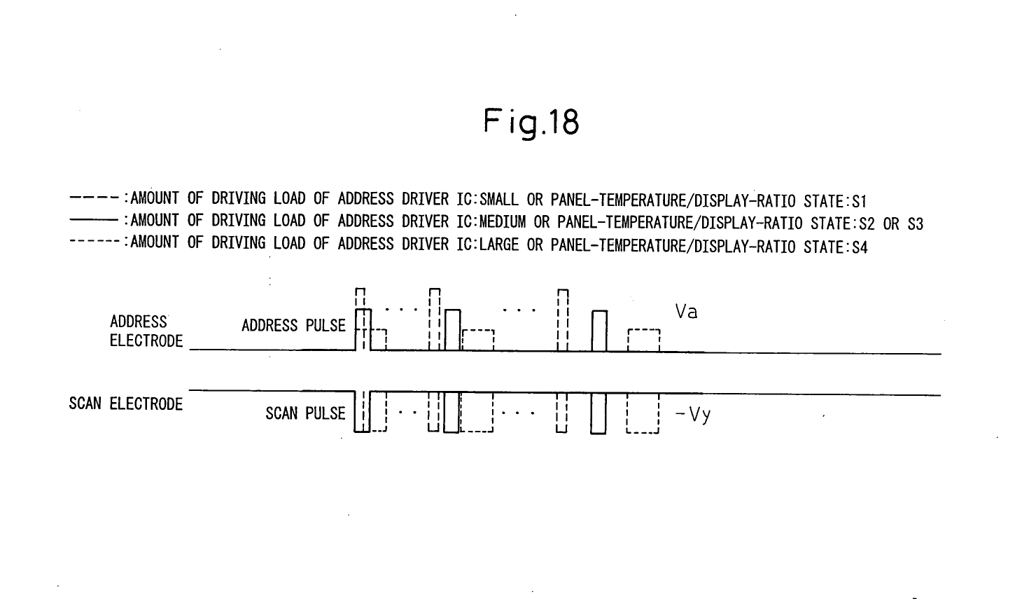

FIG. 18 is a diagram for explaining an eighth embodiment of the flat display apparatus according to the present invention.

In the eighth embodiment of the flat display apparatus shown in FIG. 18, the configuration in which the pulse width of the drive pulse is also varied in accordance with the magnitude (small, medium, or large) of the amount of driving load of the address driver IC or the panel-temperature/display-ratio state S1 to S4 is applied to the address pulse (Va) that forms part of the write pulse (Vw). In this case, as shown in FIG. 18, the pulse width of the scan pulse held at a constant voltage must also be varied to correspond with the varied pulse width of the address pulse, in order to generate an address discharge (write discharge) in each cell on the selected scan line (Y electrode).

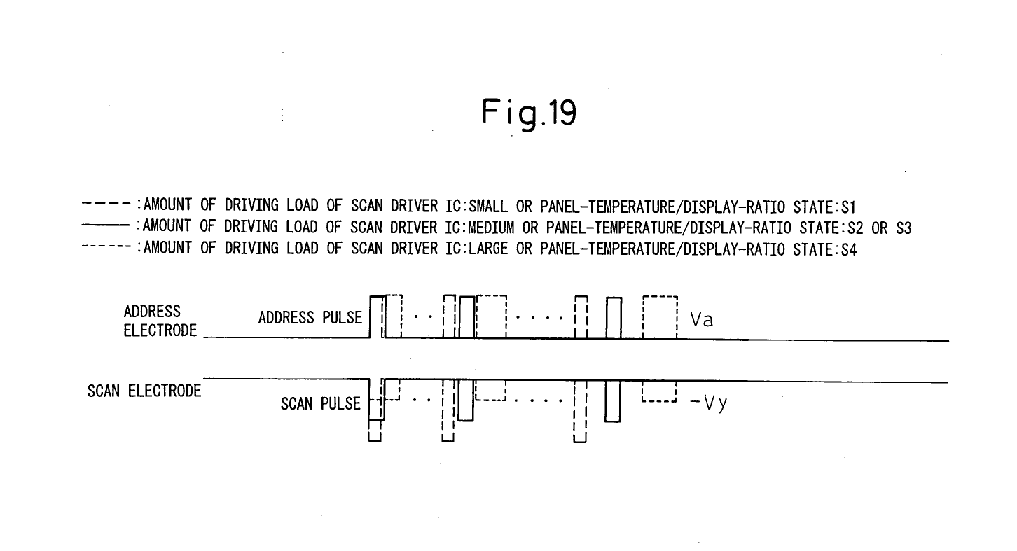

FIG. 19 is a diagram for explaining a ninth embodiment of the flat display apparatus according to the present invention.

In the ninth embodiment of the flat display apparatus shown in FIG. 19, the configuration in which the pulse width of the drive pulse is also varied in accordance with the magnitude (small, medium, or large) of the amount of driving load of the scan driver IC or the panel-temperature/display-ratio state S1 to S4 is applied to the scan pulse (−Vy) that forms part of the write pulse (Vw). In this case, as shown in FIG. 19, the pulse width of the address pulse held at a constant voltage must also be varied to correspond with the varied pulse width of the scan pulse, in order to generate an address discharge in each cell on the selected scan line.

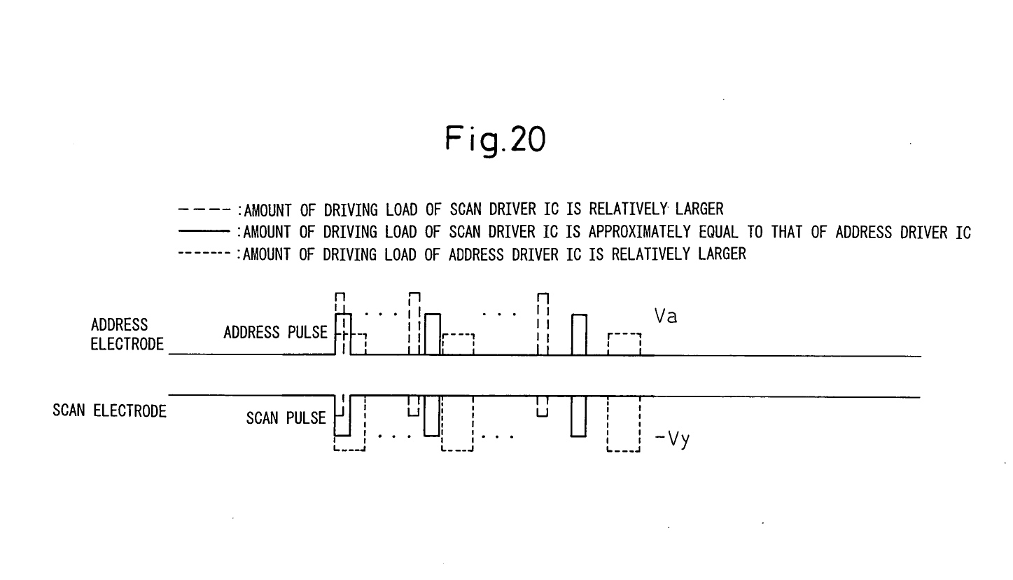

FIG. 20 is a diagram for explaining a 10th embodiment of the flat display apparatus according to the present invention.

As shown in FIG. 20, the 10th embodiment of the flat display apparatus is one in which the pulse widths of the address pulse and the scan pulse are simultaneously varied in accordance with the magnitude of the address-pulse voltage Va while maintaining the sum write voltage value at a substantially constant or a slightly lower level.

The 10th embodiment of the flat display apparatus offers the effect that the address-pulse voltage can be reduced in a concentrated and reliable manner.

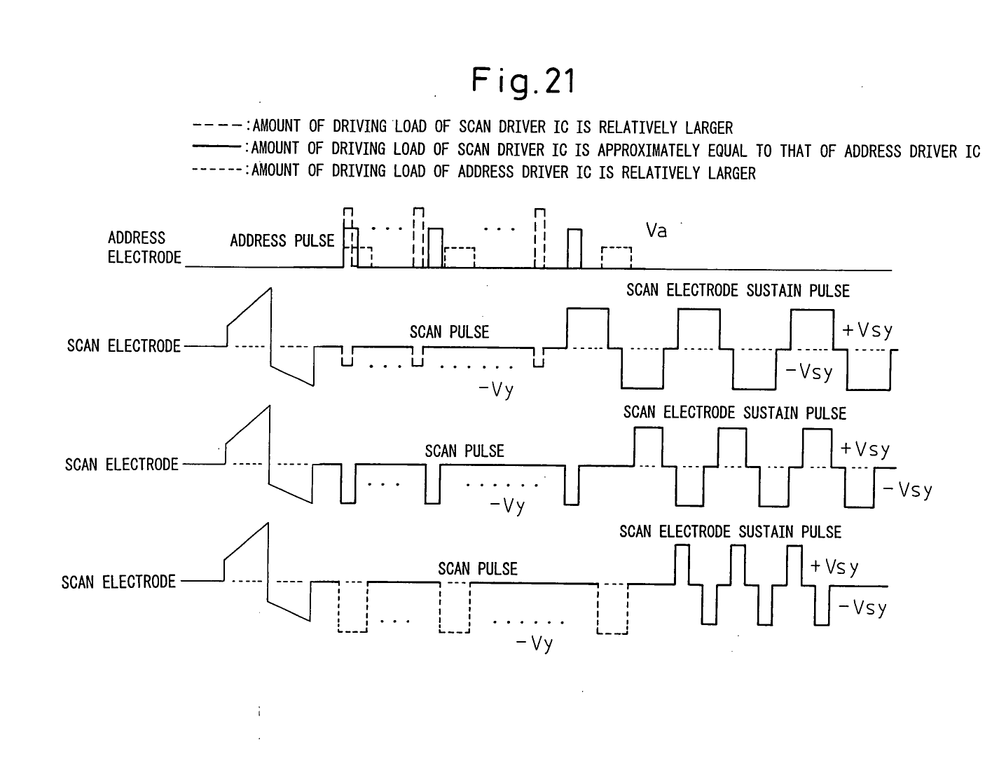

FIG. 21 is a diagram for explaining an 11th embodiment of the flat display apparatus according to the present invention, and shows the driving waveforms when the write pulse waveforms explained in the eighth to 10th embodiments are actually applied.

As shown in FIG. 21, the 11th embodiment of the flat display apparatus is one in which, since the length of the address period (TA) changes when the pulse width of the write pulse is varied in accordance with the amount of driving load of the scan driver IC or the address driver IC, the change is absorbed by correspondingly varying the sustain pulse width in the sustain period (TS), thereby ensuring that the overall length of one frame (one field) period remains unchanged.

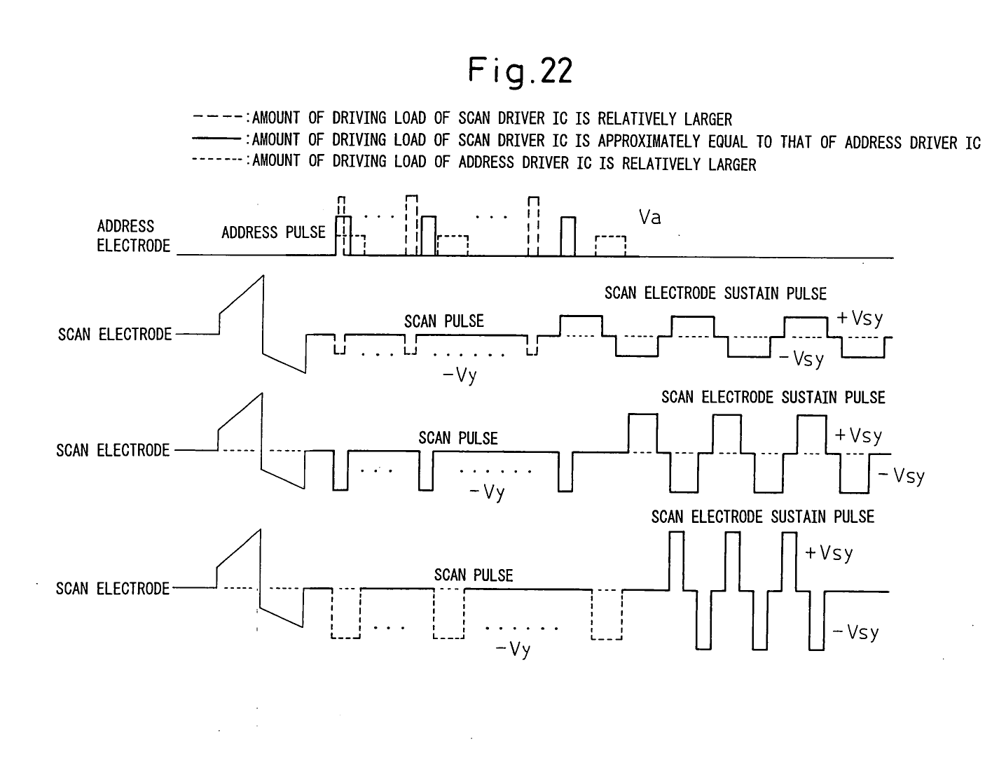

FIG. 22 is a diagram for explaining a 12th embodiment of the flat display apparatus according to the present invention.

In the above-described 11th embodiment of the flat display apparatus, the sustain pulse width was simply varied, but in the 12th embodiment of the flat display apparatus shown in FIG. 22, the configuration described with reference to FIG. 17 is applied to the sustain pulse, and the sustain-pulse voltage is varied in a manner inversely proportional to the pulse width of the sustain pulse.

According to the 12th embodiment of the flat display apparatus, variations including the variation of the sustain pulse can be addressed in a further reliable manner.

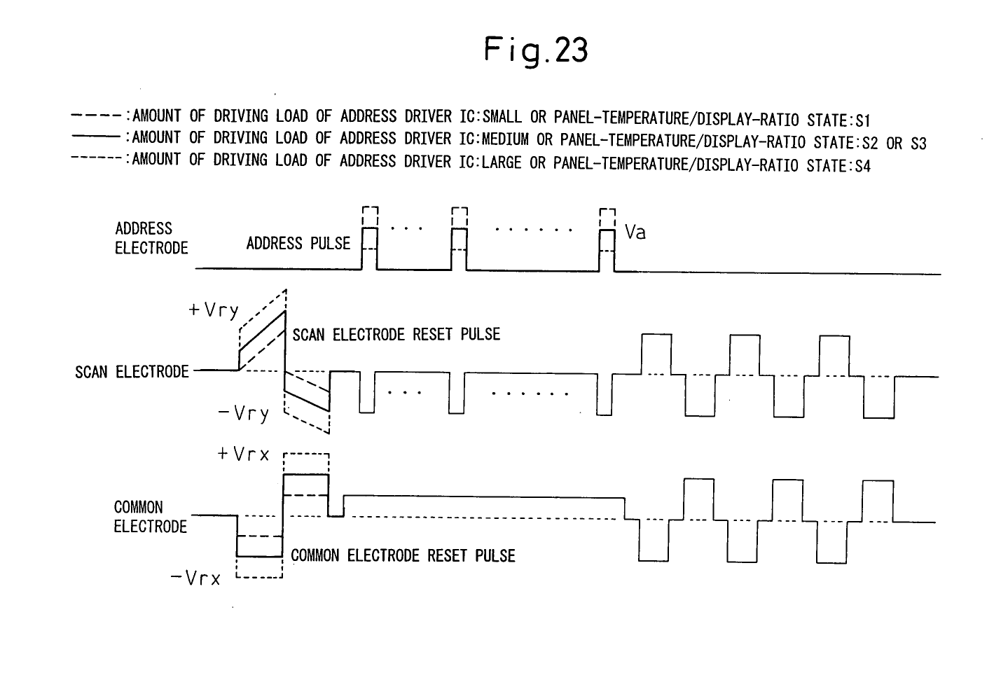

FIG. 23 is a diagram for explaining a 13th embodiment of the flat display apparatus according to the present invention.

As shown in FIG. 23, the 13th embodiment of the flat display apparatus is one in which, as an operation performed in the reset period TR to initialize the amount of wall charge in each discharge cell, the amount of initial wall charge is controlled in accordance with the amount of driving load of the address driver IC.

More specifically, in the 13th embodiment of the flat display apparatus, when the amount of driving load of the address driver IC increases, or when the panel-temperature/display-ratio state transitions toward S4, the reset-pulse voltage is increased to generate a larger amount of initial wall charge, but conversely, when the amount of driving load of the address driver IC decreases, or when the panel-temperature/display-ratio state transitions toward S1, the reset-pulse voltage is reduced to generate a smaller amount of initial wall charge.

In this way, in the reset period TR, when the amount of driving load of the address driver IC increases, or when the panel-temperature/display-ratio state transitions toward S4, the reset-pulse voltage is increased to generate a larger amount of initial wall charge, thereby making it easier for the write discharge to occur in the subsequent address period TA and thus equivalently reducing the required write-pulse voltage. By performing the above operation when the amount of driving load of the address driver IC increases or when the panel-temperature/display-ratio state transitions toward S4, the address-pulse voltage can be set lower.

The amount of initial wall charge can be controlled not only by controlling the reset-pulse voltage but also by controlling the pulse width of the reset pulse, and the amount of initial wall charge can also be increased by increasing the pulse width.

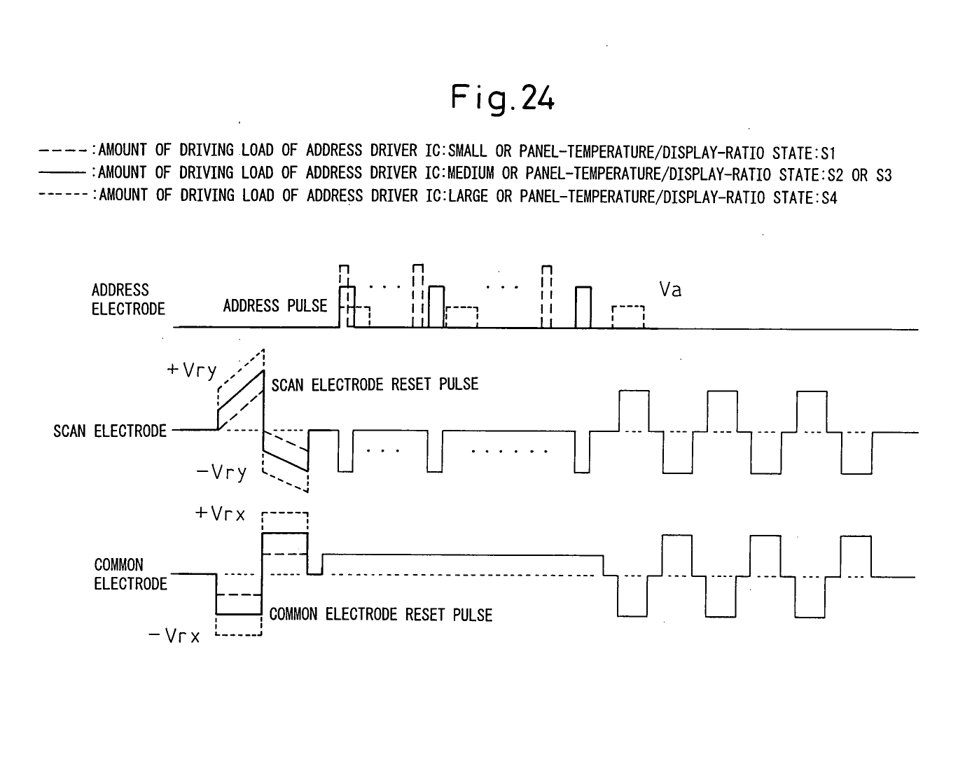

FIG. 24 is a diagram for explaining a 14th embodiment of the flat display apparatus according to the present invention.

As shown in FIG. 24, the 14th embodiment of the flat display apparatus is one in which the pulse width of the write pulse is also varied in the above-described 13th embodiment; that is, when the amount of driving load of the address driver IC increases, or when the panel-temperature/display-ratio state transitions toward S4, the reset-pulse voltage is increased to generate a larger amount of initial wall charge and, at the same time, the pulse width of the write pulse is increased while reducing the write-pulse voltage. FIG. 24 shows as an example the case where the voltage and pulse width of the address pulse are varied, but the other drive pulses are also varied in the same manner. According to the 14th embodiment of the flat display apparatus, more reliable and stable operation can be achieved.

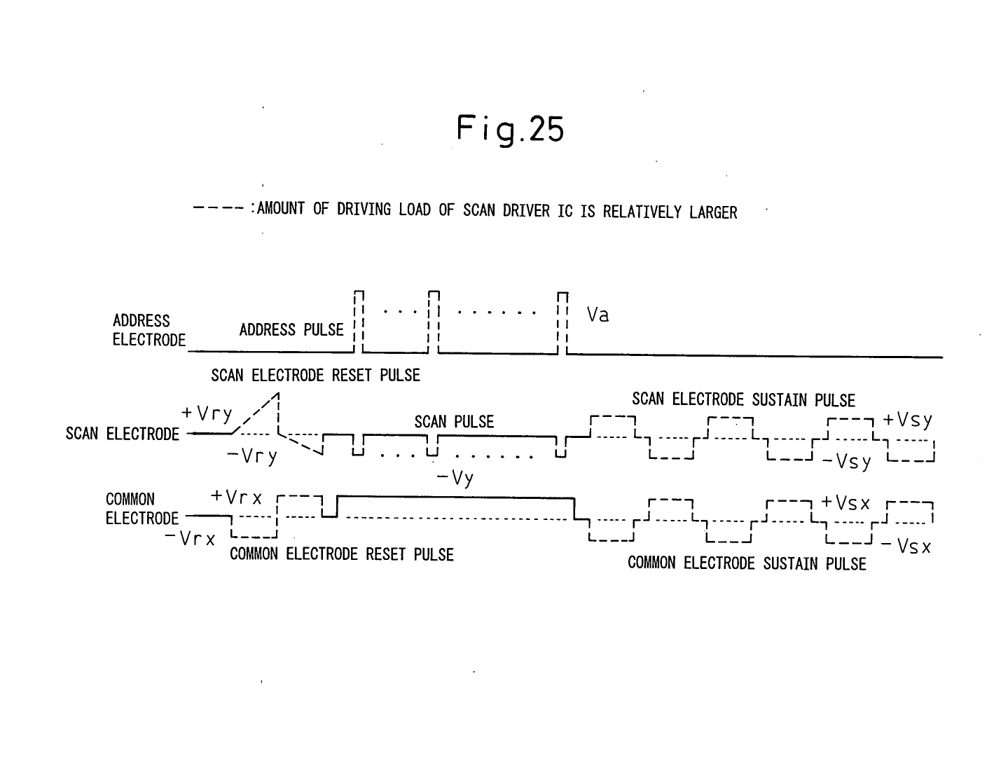

FIGS. 25 to 27 are diagrams for explaining a 15th embodiment of the flat display apparatus according to the present invention, and show examples of driving waveforms when the various methods of control are combined, that is, the driving voltage is controlled in accordance with the panel temperature and display ratio states as explained with reference to FIG. 8, while also controlling the pulse width of the driving voltage in accordance with the panel temperature and display ratio states as explained with reference to FIG. 17 and further controlling the amount of initial wall charge by the reset pulse as described above.

That is, in the 15th embodiment of the flat display apparatus, the amount of driving load of the address driver IC is compared with that of the scan driver IC and, based on the result of the comparison, the driving waveform is controlled in the following manner.

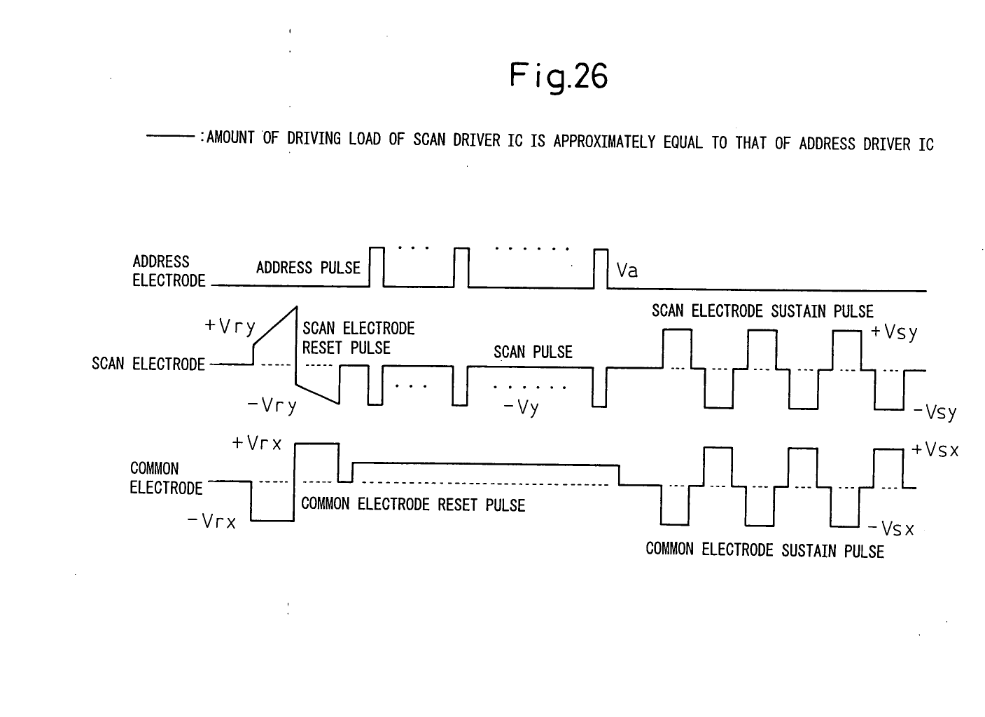

First, when the amount of driving load of the address driver IC is approximately equal to that of the scan driver IC, the voltages of all the drive pulses, such as the reset pulse, the write pulse, and the sustain pulse, and their pulse widths are set to well balanced average values, as shown in FIG. 26. However, for the write pulse, the scan voltage Vy is set higher than the address voltage Va, as previously described in the fourth embodiment with reference to FIG. 12. Here, FIG. 26 is only a schematic illustration and is drawn by ignoring such a voltage difference.

When the amount of driving load of the scan driver IC increases from the above average state and becomes higher than that of the address driver IC, the scan electrode (Y electrode) and common electrode (X electrode) sustain-pulse voltages are reduced, while increasing their pulse widths, as shown in FIG. 25. At this time, since the address period becomes shorter, the pulse width of the write pulse is reduced, while increasing its voltage. In FIG. 25, the address-pulse voltage is increased. Here, since the write voltage is increased, the reset-pulse voltage is reduced to reduce the amount of initial wall charge.

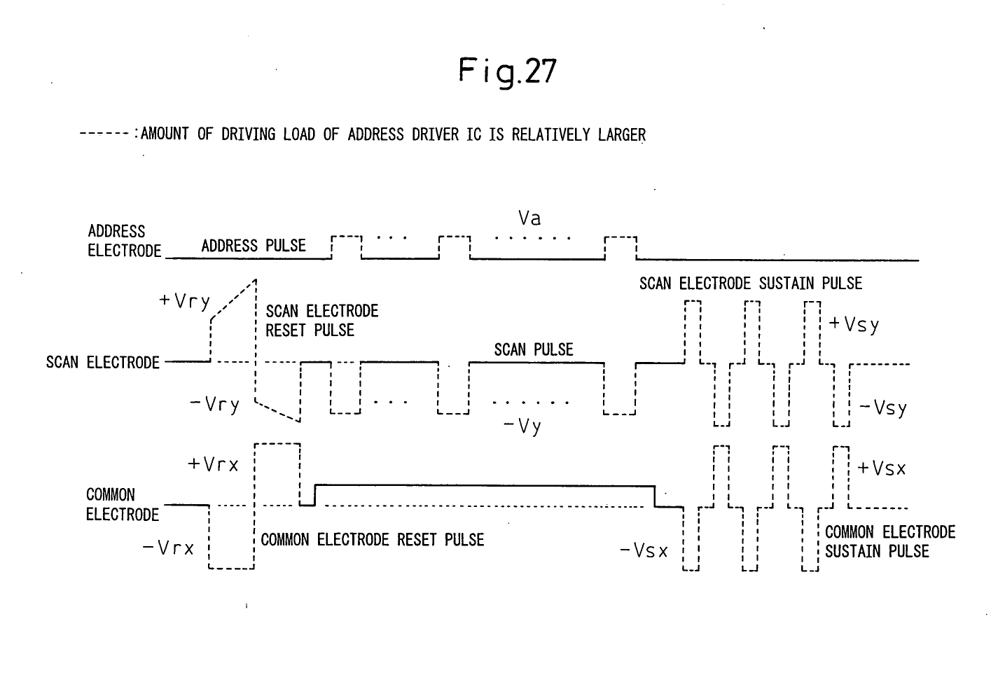

On the other hand, when the amount of driving load of the address driver IC increases from the above average state and becomes higher than that of the scan driver IC, the address-pulse voltage is reduced, while increasing its pulse width, as shown in FIG. 27. At this time, since the sustain period becomes shorter, the sustain pulse width is reduced for both the scan electrode and the common electrode side, while increasing their voltages. In FIG. 27, the sustain-pulse voltage is increased. Here, since the address-pulse voltage is reduced, the reset-pulse voltage is increased to increase the amount of initial wall charge.

According to the 15th embodiment of the flat display apparatus, both the address driver IC and the scan driver IC need only be designed to handle average loads and need not be designed to handle excessive loads and, as a whole, the size and cost of the apparatus can be reduced.

While each of the above embodiments has been described in detail by primarily taking as an example the three-electrode surface-discharge AC-driven type plasma display apparatus, it will be appreciated that the present invention can be widely applied to flat display apparatus having such characteristics that the panel driving voltage decreases as the data display ratio or the panel temperature increases, not to mention two-electrode AC-driven type plasma display apparatus that utilize the gas discharge phenomenon. In particular, the present invention offers a great effect when applied to a flat display apparatus that is self-emissive and that consumes relatively large power.

As described above, according to the present invention, the power consumption of the driving circuits (driver ICs) for driving the display electrodes of a flat display panel can be reduced, while equalizing the power consumption between the respective driving circuits, and the design of each driving circuit, in particular, the heat sink design, can be simplified, achieving reductions in the overall size and cost of the apparatus.

### INDUSTRIAL APPLICABILITY

The present invention can be widely applied to flat display apparatus, particularly to display apparatus for personal computers, workstations, etc. and other flat display apparatus such as plasma display apparatus that are self-emissive, can achieve a large-screen display, and consume relatively large power and that are used as hang-on-the-wall televisions or as apparatus for displaying advertisements, information, etc.

1. A flat display apparatus having:
a flat display panel in which at least some of display electrodes are formed from a scan electrode and an address electrode arranged so as to intersect each other;
a scan driver which is connected to the scan electrode and supplies a driving voltage waveform to the scan electrode;
an address driver which is connected to the address electrode and supplies a driving voltage waveform to the address electrode; and
a control circuit which controls operation of driving circuits in the flat display panel, the driving circuits including the scan driver and the address driver, wherein the flat display apparatus comprises:
a driving load detecting unit detecting an amount of driving load for the scan driver or the address driver; and
a driving voltage varying unit varying, based on the detected amount of driving load, a driving voltage for the scan electrode or a driving voltage for the address electrode.

2. The flat display apparatus as claimed in claim 1, wherein the driving load detecting unit detects the amount of driving load for the scan driver or the address driver in accordance with a data display ratio on the flat display panel.

3. The flat display apparatus as claimed in claim 1, wherein the scan driver is constructed as a scan driver IC, and the address driver is constructed as an address driver IC, and wherein
the driving load detecting unit includes a temperature sensor detecting a temperature of the scan driver IC or the address driver IC, and detects the amount of driving load for the scan driver or the address driver from the temperature detected on the scan driver IC or the address driver IC.

4. The flat display apparatus as claimed in claim 1, wherein the address driver is constructed as an address driver IC, and wherein
the driving load detecting unit includes a current sensor detecting a current value of the address driver IC, and detects the amount of driving load for the address driver from the current detected on the address driver IC.

5. The flat display apparatus as claimed in claim 1, wherein the flat display apparatus has a characteristic such that as a data display ratio on the flat display panel increases, activation energy of discharge gas increases and the driving voltage decreases, and wherein
as the detected amount of driving load increases, the driving voltage varying unit decreases the driving voltage of the scan electrode or the driving voltage of the address electrode.

6. A flat display apparatus having:
a flat display panel in which at least some of display electrodes are formed from a scan electrode and an address electrode arranged so as to intersect each other;
a scan driver which is connected to the scan electrode and supplies a driving voltage waveform to the scan electrode;
an address driver which is connected to the address electrode and supplies a driving voltage waveform to the address electrode; and
a control circuit which controls operation of driving circuits in the flat display panel, the driving circuits including the scan driver and the address driver, wherein the flat display apparatus comprises:
a panel temperature detecting unit detecting the temperature of the flat display panel; and
a driving voltage varying unit varying, based on the detected temperature of the flat display panel, a driving voltage for the scan electrode or a driving voltage for the address electrode.

7. The flat display apparatus as claimed in claim 6, wherein the flat display apparatus has a characteristic such that as the temperature of the flat display panel rises, activation energy of discharge gas increases and the driving voltage decreases, and wherein
as the detected temperature of the flat display panel rises, the driving voltage varying unit decreases the driving voltage of the scan electrode or the driving voltage of the address electrode.

8. The flat display apparatus as claimed in claim 1, further comprising an application voltage proportion varying unit varying relative proportions of voltages to be applied to the scan electrode and the address electrode, while keeping the magnitude of a sum voltage of the driving voltage of the scan electrode and the driving voltage of the address electrode substantially unchanged.

9. The flat display apparatus as claimed in claim 1, further comprising a driving time duration varying unit varying a driving time duration for the scan electrode or the address electrode in accordance with the driving voltage of the scan electrode or the address electrode.

10. The flat display apparatus as claimed in claim 9, further comprising a voltage time duration varying unit varying the driving voltage of the scan electrode in a manner inversely proportional to the driving time duration thereof or varying the driving voltage of the address electrode in a manner inversely proportional to the driving time duration thereof.

11. The flat display apparatus as claimed in claim 1, wherein the waveform for driving the scan electrode includes a scan pulse for selecting display pixels on the scan electrode, a sustain pulse for sustaining the display pixels, and a reset pulse for initializing a screen prior to the selection of the display pixels, and
the waveform for driving the address electrode includes an address pulse for selecting display pixels on the address electrode, and wherein
the flat display apparatus further comprises a pulse voltage varying unit varying, based on the detected amount of driving load or on the detected temperature of the panel, the driving voltage of one kind of pulse selected from among the scan pulse, the sustain pulse, the reset pulse, and the address pulse.

12. The flat display apparatus as claimed in claim 1, wherein the flat display panel is a plasma display panel.

13. A flat display apparatus having:
a flat display panel in which at least some of display electrodes are formed from a scan electrode and an address electrode arranged so as to intersect each other and a common electrode as a sustain electrode arranged in parallel to the scan electrode;
a scan driver which is connected to the scan electrode and supplies a driving voltage waveform to the scan electrode;
an address driver which is connected to the address electrode and supplies a driving voltage waveform to the address electrode;
a common electrode driver which is connected to the common electrode and supplies a driving voltage waveform to the common electrode; and
a control circuit which controls operation of driving circuits in the flat display panel, the driving circuits including the scan driver, the address driver, and the common electrode driver, wherein the flat display apparatus comprises:
a driving load detecting unit detecting an amount of driving load for the scan driver, the address driver, or the common electrode driver; and
a driving voltage varying unit varying, based on the detected amount of driving load, a driving voltage for the scan electrode, a driving voltage for the address electrode, or a driving voltage for the common electrode driver.

14. The flat display apparatus as claimed in claim 13, wherein the driving load detecting unit detects the amount of driving load for the scan driver, the address driver, or the common electrode driver in accordance with a data display ratio on the flat display panel.

15. The flat display apparatus as claimed in claim 13, wherein the scan driver is constructed as a scan driver IC, the address driver is constructed as an address driver IC, and wherein
the driving load detecting unit includes a temperature sensor detecting a temperature of the scan driver IC, the address driver IC, or the common electrode driver IC, and detects the amount of driving load for the scan driver, the address driver, or the common electrode driver from the temperature of the scan driver IC, the address driver IC, or the common electrode driver IC detected by the temperature sensor.

16. The flat display apparatus as claimed in claim 13, wherein the scan driver is provided with an X-common driver for driving the scan electrode via the scan driver, the common driver is provided with a Y-common driver for driving the common electrode, and a sustain discharge is produced by the X-common driver and the Y-common driver.

17. The flat display apparatus as claimed in claim 16, wherein the scan driver is constructed as a scan driver IC, the address driver is constructed as an address driver IC, and wherein
the driving load detecting unit includes a current sensor detecting a current value of the scan driver IC, the address driver IC, or the common electrode driver IC, and detects the amount of driving load for the scan driver, the address driver, or the common electrode driver from the current of the scan driver IC, the address driver IC, or the common electrode driver IC detected by the current sensor.

18. The flat display apparatus as claimed in claim 13, wherein the flat display apparatus has a characteristic such that as a data display ratio on the flat display panel increases, activation energy of discharge gas increases and the driving voltage decreases, and wherein
as the detected amount of driving load increases, the driving voltage varying unit decreases the driving voltage of the scan electrode, the driving voltage of the address electrode, or the driving voltage of the common electrode driver.

19. A flat display apparatus having:
a flat display panel in which at least some of display electrodes are formed from a scan electrode and an address electrode arranged so as to intersect each other and a common electrode as a sustain electrode arranged in parallel to the scan electrode;
a scan driver which is connected to the scan electrode and supplies a driving voltage waveform to the scan electrode;
an address driver which is connected to the address electrode and supplies a driving voltage waveform to the address electrode;
a common electrode driver which is connected to the common electrode and supplies a driving voltage waveform to the common electrode; and
a control circuit which controls operation of driving circuits in the flat display panel, the driving circuits including the scan driver, the address driver, and the common electrode driver, wherein the flat display apparatus comprises:
a panel temperature detecting unit detecting the temperature of the flat display panel; and
a driving voltage varying unit varying, based on the detected temperature of the flat display panel, a driving voltage for the scan electrode, a driving voltage for the address electrode, or a driving voltage for the common electrode driver.

20. The flat display apparatus as claimed in claim 19, wherein the flat display apparatus has a characteristic such that as the temperature of the flat display panel rises, activation energy of discharge gas increases and the driving voltage decreases, and wherein
as the detected temperature of the flat display panel rises, the driving voltage varying unit decreases the driving voltage of the scan electrode, the driving voltage of the address electrode, or the driving voltage of the common electrode driver.

21. The flat display apparatus as claimed in claim 13, further comprising an application voltage proportion varying unit varying relative proportions of voltages to be applied to two electrodes selected from among the scan electrode, the address electrode, and the common electrode, while keeping the magnitude of a sum voltage of the driving voltages to be applied to the two electrodes substantially unchanged.

22. The flat display apparatus as claimed in claim 13, further comprising a driving time duration varying unit varying a driving time duration for the scan electrode, the address electrode, or the common electrode in accordance with the driving voltage of the scan electrode, the address electrode, or the common electrode.

23. The flat display apparatus as claimed in claim 23, further comprising a voltage time duration varying unit varying the driving voltage of the scan electrode in a manner inversely proportional to the driving time duration thereof, varying the driving voltage of the address electrode in a manner inversely proportional to the driving time duration thereof, or varying the driving voltage of the common electrode in a manner inversely proportional to the driving time duration thereof.

24. The flat display apparatus as claimed in claim 13, wherein the waveform for driving the scan electrode includes a scan pulse for selecting display pixels on the scan electrode, a scan-electrode-side sustain pulse for sustaining the display pixels, and a scan-electrode-side reset pulse for initializing a screen prior to the selection of the display pixels, and
the waveform for driving the address electrode includes an address pulse for selecting display pixels on the address electrode, and wherein
the flat display apparatus further comprises a pulse voltage varying unit varying, based on the detected amount of driving load or on the detected temperature of the panel, the driving voltage of one kind of pulse selected from among the scan pulse, the scan-electrode-side sustain pulse, the scan-electrode-side reset pulse, the address pulse, a common-electrode-side sustain pulse, and a common-electrode-side reset pulse.

25. The flat display apparatus as claimed in claim 13, wherein the flat display panel is a three-electrode surface-discharge AC-driven type plasma display apparatus.

26. A driving method for a flat display apparatus that comprises a flat display panel in which at least some of display electrodes are formed from a scan electrode and an address electrode arranged so as to intersect each other, the flat display apparatus having a characteristic such that as the amount of driving load of the flat display panel increases, activation energy of discharge gas increases and a driving voltage decreases, wherein the method is characterized in that when the amount of driving load of the flat display panel increases, the driving voltage of the scan electrode or the address electrode is reduced.

27. The driving method for the flat display apparatus as claimed in claim 26, wherein the amount of driving load of the flat display panel is obtained by measuring a data display ratio on the flat display panel, or a temperature on an IC for driving the scan electrode or the address electrode, or a current being consumed by the IC for driving the scan electrode or the address electrode.

28. A driving method for a flat display apparatus that comprises a flat display panel in which at least some of display electrodes are formed from a scan electrode and an address electrode arranged so as to intersect each other, the flat display apparatus having a characteristic such that as the temperature of the flat display panel rises, activation energy of discharge gas increases and a driving voltage decreases, wherein the method is characterized in that when the temperature of the flat display panel rises, the driving voltage of the scan electrode or the address electrode is reduced.

29. The driving method for the flat display apparatus as claimed in claim 26, wherein relative proportions of voltages to be applied to the scan electrode and the address electrode are varied while keeping the magnitude of a sum voltage of the driving voltage of the scan electrode and the driving voltage of the address electrode.

30. The driving method for the flat display apparatus as claimed in claim 26, wherein the driving voltage of the scan electrode or the address electrode is varied in a manner inversely proportional to the driving time duration of the scan electrode or the address electrode.

31. The driving method for the flat display apparatus as claimed in claim 26, wherein a waveform for driving the scan electrode includes a scan pulse for selecting display pixels on the scan electrode, a sustain pulse for sustaining the display pixels, and a reset pulse for initializing a screen prior to the selection of the display pixels, and
a waveform for driving the address electrode includes an address pulse for selecting display pixels on the address electrode, and wherein
the driving voltage of one kind of pulse selected from among the scan pulse, the sustain pulse, the reset pulse, and the address pulse is varied based on the detected amount of driving load or on the detected temperature of the panel.

32. The driving method for the flat display apparatus as claimed in claim 26, wherein the flat display panel is a plasma display panel.

33. A driving method for a flat display apparatus that comprises a flat display panel in which at least some of display electrodes are formed from a scan electrode and an address electrode arranged so as to intersect each other and a common electrode as a sustain electrode arranged in parallel to the scan electrode, the flat display apparatus having a characteristic such that as the amount of driving load of the flat display panel increases, activation energy of discharge gas increases and a driving voltage decreases, wherein the method is characterized in that when the amount of driving load of the flat display panel increases, the driving voltage of the scan electrode, the address electrode, or the common electrode is reduced.

34. The driving method for the flat display apparatus as claimed in claim 33, wherein the amount of driving load of the flat display panel is obtained by measuring a data display ratio on the flat display panel, or a temperature on an IC for driving the scan electrode, the address electrode, or the common electrode, or a current being consumed by the IC for driving the scan electrode, the address electrode, or the common electrode.

35. A driving method for a flat display apparatus that comprises a flat display panel in which at least some of display electrodes are formed from a scan electrode and an address electrode arranged so as to intersect each other and a common electrode as a sustain electrode arranged in parallel to the scan electrode, the flat display apparatus having a characteristic such that as the temperature of the flat display panel rises, activation energy of discharge gas increases and a driving voltage decreases, wherein the method is characterized in that when the temperature of the flat display panel rises, the driving voltage of the scan electrode, the address electrode, or the common electrode is reduced.

36. The driving method for the flat display apparatus as claimed in claim 33, wherein the flat display apparatus comprises an application voltage proportion varying unit varying relative proportions of voltages to be applied to two electrodes selected from among the scan electrode, the address electrode, and the common electrode, while keeping the magnitude of a sum voltage of the driving voltages to be applied to the two electrodes substantially unchanged.

37. The driving method for the flat display apparatus as claimed in claim 33, wherein the driving voltage of the scan electrode, the address electrode, or the common electrode is varied in a manner inversely proportional to the driving time duration of the scan electrode, the address electrode, or the common electrode.

38. The driving method for the flat display apparatus as claimed in claim 33, wherein a waveform for driving the scan electrode includes a scan pulse for selecting display pixels on the scan electrode, a scan-electrode-side sustain pulse for sustaining the display pixels, and a scan-electrode-side reset pulse for initializing a screen prior to the selection of the display pixels, and
a waveform for driving the address electrode includes an address pulse for selecting display pixels on the address electrode, and wherein
the driving voltage of one kind of pulse selected from among the scan pulse, the scan-electrode-side sustain pulse, the scan-electrode-side reset pulse, the address pulse, a common-electrode-side sustain pulse, and a common-electrode-side reset pulse is varied based on the detected amount of driving load or on the detected temperature of the panel.

39. The driving method for the flat display apparatus as claimed in claim 33, wherein the flat display panel is a three-electrode surface-discharge AC-driven type plasma display apparatus.
